(19) United States
(12) Patent Application Publication
(10) Pub. No.: US 2026/0122036 A1
(43) Pub. Date: Apr. 30, 2026

(54) Methods and Systems for Application Layer Event Classification Through a Synthetic Indicator in a Shared Infrastructure Computing Environment

(71) Applicant: Salesforce, Inc., San Francisco, CA (US)

(72) Inventors: Simone MAINARDI, Dublin (IE); Prabhat SINGH, San Jose, CA (US); Kaushal BANSAL, Alamo, CA (US)

(21) Appl. No.: 18/956,782

(22) Filed: Nov. 22, 2024

Related U.S. Application Data
(60) Provisional application No. 63/713,158, filed on Oct. 29, 2024.

(51) Int. Cl. H04L 9/40; G06N 7/01

(52) U.S. Cl. CPC H04L 63/0245; G06N 7/01

(57) ABSTRACT

Application servers may provide computing services to entities. A network ingress may receive application-level request messages and forward some or all of the request messages to an application server. A data aggregator may determine data buckets based on the application-level request messages. A data bucket may include information characterizing one or more features. The information may be determined based on a subset of the application-level request messages received during a respective period of time. A request analyzer may determine one or more of the data buckets and one or more of the features for analyzing an application-level request message and may determine a synthetic indicator for the request based on the one or more data buckets and the one or more features. A web application firewall may block the application-level request message upon determining that the synthetic indicator indicates that the request is illegitimate.

### CROSS-REFERENCE TO RELATED APPLICATIONS

This patent application claims priority to Provisional U.S. Patent Application No. 63/713,158 by Mainardi et al., filed Oct. 29, 2024, titled “Methods And Systems for Application Layer Event Classification Through a Synthetic Indicator in a Shared Infrastructure Computing Environment”, which is hereby incorporated by reference in its entirety and for all purposes.

### FIELD OF TECHNOLOGY

This patent application relates generally to network attack detection and mitigation, and more specifically to application layer defense of a shared infrastructure against a distributed denial of service attack.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks. For example, users may interact with website hosting services implemented in cloud comp environments to access website. Such interactions may be conducted via any of various types of devices, such as mobile devices and/or computer systems. Given the prevalence of application layer Distributed Denial of Service (DDoS) attacks, improved techniques for detecting and mitigating DDoS attacks with database systems are desired.

### BRIEF DESCRIPTION OF THE DRAWINGS

The included drawings are for illustrative purposes and serve only to provide examples of possible structures and operations for the disclosed inventive systems, apparatus, methods, and computer program products for application layer detection and mitigation of a distributed denial of service attack on a shared infrastructure. These drawings in no way limit any changes in form and detail that may be made by one skilled in the art without departing from the spirit and scope of the disclosed implementations.

FIG. 1 illustrates an overview method for application-layer distributed denial of service attack detection and mitigation, performed in accordance with one or more embodiments.

FIG. 2 illustrates one example of a computing services environment, configured in accordance with one or more embodiments.

FIG. 3 illustrates an example of an overview flowchart illustrating various operations performed in the course of identifying and mitigating an application-layer DDoS attack, configured in accordance with one or more embodiments.

FIG. 4 illustrates one example of a response diagram, generated in accordance with one or more embodiments.

FIG. 5 illustrates a method of application-layer distributed denial of service attack detection and mitigation response, performed in accordance with one or more embodiments.

FIG. 6 illustrates a method of application-layer distributed denial of service attack traffic spike evaluation, performed in accordance with one or more embodiments.

FIG. 7 illustrates a method of determining an application-layer distributed denial of service attack mitigation policy, performed in accordance with one or more embodiments.

FIG. 8 illustrates a method of application-layer distributed denial of service attack mitigation post mitigation monitoring, performed in accordance with one or more embodiments.

FIG. 9 illustrates an overview method for application-layer distributed denial of service attack mitigation configuration, performed in accordance with one or more embodiments.

FIG. 10 illustrates one example of a computing services environment, configured in accordance with one or more embodiments.

FIG. 11 illustrates a method of application-layer distributed denial of service orchestrator attack mitigation activation, performed in accordance with one or more embodiments.

FIG. 12 illustrates a method of application-layer distributed denial of service mitigation policy state updating, performed in accordance with one or more embodiments.

FIG. 13 illustrates a method of application-layer distributed denial of service orchestrator attack mitigation deactivation, performed in accordance with one or more embodiments.

FIG. 14 illustrates an overview method for filtering application-layer messages at a computing services environment, performed in accordance with one or more embodiments.

FIG. 15 illustrates an architecture diagram showing interactions between various components associated with traffic filtering, configured in accordance with one or more embodiments.

FIG. 16 illustrates a method for aggregating traffic data, performed in accordance with one or more embodiments.

FIG. 17 illustrates a diagram showing a division of traffic aggregation data determined in accordance with one or more embodiments.

FIG. 18 illustrates a method for evaluating an event, performed in accordance with one or more embodiments.

FIG. 19, which illustrates a diagram showing various inputs to score computation, configured in accordance with one or more embodiments.

FIG. 20 illustrates a method for determining and incorporating traffic data feedback method, performed in accordance with one or more embodiments.

FIG. 21 shows a block diagram of an example of an environment that includes an on-demand database service configured in accordance with some implementations.

FIG. 22A shows a system diagram of an example of architectural components of an on-demand database service environment, configured in accordance with some implementations.

FIG. 22B shows a system diagram further illustrating an example of architectural components of an on-demand database service environment, in accordance with some implementations.

FIG. 23 illustrates one example of a computing device, configured in accordance with one or more embodiments.

### DETAILED DESCRIPTION

### Introduction

Techniques and mechanisms described herein provide for improved classification of true and false positive application-level networking attacks based on historical baselines. The system improves upon static detection thresholds by basing the classification on past traffic patterns, thereby reducing the generation of false positives. A synthetic indicator score distills a multi-dimensional comparison of a current traffic event to potentially multiple aggregations of previous traffic patterns into a single number, which acts as a distilled indicator of the likelihood of an event being an attack. By comparing current traffic against historical baselines, the score provides a clear, scalar value that simplifies the decision-making process. This approach helps in quickly identifying anomalies, making it easier to interpret and act upon malicious events.

Techniques and mechanisms described herein provide for an application-layer DDoS attack detection and mitigation system for a shared infrastructure. A DDoS attack disrupts the availability and resources available to endpoints. To address this problem, techniques and mechanisms describe herein provide for detecting the attack and then determining and implementing an appropriate mitigation policy across potentially multiple ingress paths to the shared infrastructure. The system may determine the severity of the attack based on the traffic spike using historical data. The system may also use one or more artificial intelligence models throughout the detection and mitigation phases to improve confidence in its suggestions.

In today's cybersecurity landscape, the increasing frequency and complexity of Layer 7 Distributed Denial of Service (L7 DDoS) attacks demand advanced defensive strategies. Layer 7 refers to the top layer in the 7-layer Open Systems Interconnection (OSI) Model of the Internet. It is also known as the “application layer.” Layer 7 is the top layer of the data processing that occurs just below the surface or behind the scenes of software applications. For example, login requests, HTTP requests and responses used to load webpages, and other such high-level messages are layer 7 events. An L7 DDoS attack is a strategy that involves sending many malicious application-layer requests in an effort to overwhelm recipient web servers and undermine the services that they provide.

L7 DDoS attacks are particularly challenging to address because responding to an application layer message typically requires many more resources than transmitting an application layer request. For example, sending a login request or a webpage request typically involves few resources and limited network traffic, while operations such as processing a login request, generating a webpage, and sending a webpage typically involve many more processing and network resources. This discrepancy in resource utilization also makes L7 DDoS attacks are particularly attractive to attackers.

Attacks targeting the application layer significantly jeopardize the continuity and reliability of services and infrastructure. Conventional solutions often rely on manual intervention, where engineers review attack event data and correlate it with historical trends and data to distinguish genuine traffic increases from malicious L7 DDoS activities. The overall handling of an incident requires additional steps that again heavily lean on human intervention. These manual methods are not only prone to errors but also demand substantial time and resources. For example, the process of addressing these incidents requires the coordination of multiple teams across incident response bridges, significantly increasing the operational costs associated with detection and remediation. More critically, these incidents can have a profound impact on business operations and erode customer trust, posing substantial risks to long-term business sustainability and customer relationships.

Conventional approaches for addressing L7 DDoS attacks suffer from various deficiencies. For example, rate limiting-based solutions for limiting attack traffic, such as Ngnix, typically do not differentiate the benign traffic or attack traffic during rate limiting and require significant manual configuration. For a deployment where hundreds of thousands of domains are hosted, using such a solution is impractical and due to the significant manual intervention needed, which would lead delays in detection and require significant resources. As another example, conventional public cloud DDoS solutions typically do not support specific policies for traffic directed to particular domains and do not support precise detection and mitigation actions. Such limitations again make these solutions ineffective and require significant manual intervention. Commercial DDoS solutions often rely on limited, current traffic data to make decisions and have high chances of false positives and disrupting benign customer traffic during the attack.

To address such challenges, techniques and mechanisms described herein provide for a robust system capable of swiftly detecting, evaluating, and countering L7 DDoS threats with minimal manual input. Automated and intelligent decision-making is harnessed to enhance accuracy, reduce response times, and lower the reliance on extensive human involvement in the threat mitigation process. The system directly addresses the rising frequency and complexity of Layer 7 Distributed Denial of Service (L7 DDoS) attacks. Unlike conventional solutions that depend heavily on manual intervention and retrospective analysis-approaches that are not only time-consuming and resource-intensive but also prone to inaccuracies-techniques and mechanisms described herein provide for automated detection, evaluation, and mitigation of L7 DDoS threats. By integrating intelligent decision-making algorithms that analyze real-time traffic and historical data, the system can swiftly distinguish between legitimate traffic surges and potential DDoS activities. Furthermore, the system's capacity to autonomously implement countermeasures significantly reduces the incident response time, reducing the risk to service continuity and infrastructure reliability. Thus, techniques and mechanisms described herein improve the functioning of cloud computing platforms, reduce the operational burden on cybersecurity teams, enhance the accuracy of threat detection and mitigation, and preserve the integrity of digital services against the backdrop of an evolving threat landscape.

In conventional enterprise environments, Layer 7 (L7) application protection against Distributed Denial of Service (DDoS) attacks may be achieved through various approaches including inline network devices, sidecar containers in Kubernetes deployments, and cloud-native traffic processing services offered via subscription models. Each of these methods involves operating in an inline mode, where incoming traffic is decrypted and scrutinized using signature matching or other pattern recognition techniques to identify and mitigate potential DDoS threats. Such approaches have significant drawbacks, including increased latency due to the processing of L7 packets, reduced network traffic throughput, high computing resource utilization, and significant operational costs.

Conventional approaches to application-level traffic analysis involve computationally complex calculations due to the difficulty in analyzing high-level traffic. In contrast, techniques and mechanisms described herein provide for reduced computational complexity of traffic data analysis and classification. Traffic baselines may be built over time and stored in buckets of varying sizes. These buckets can then be accessed with O(1) computational complexity for online (i.e., real-time) traffic classification.

Many conventional approaches to application-level traffic analysis are static in nature, relying on a pre-configured system to filter out particular types of traffic. In contrast, techniques and mechanisms described herein provide for a feedback loop to improve traffic classification. Attack data may be continuously fed into the system to refine the score calculation based on current outcomes, enhancing the accuracy and reliability of threat detection over time.

Techniques and mechanisms described herein provide for rapid triage. In some configurations, the synthetic indicator can be integrated into existing cybersecurity frameworks. In conjunction with an existing framework, the score can be employed to distinguish between true- and false-positive attacks. In the event of a false-positive, the framework can terminate and report the attack as resolved. Conversely, if the attack is confirmed as a true-positive, initial mitigation measures can be promptly implemented while the framework continues its execution, for instance to develop additional mitigation strategies.

Techniques and mechanisms described herein provide for post-attack analysis. The synthetic indicator can aid in identifying patterns and trends that can inform future defensive strategies and enhance understanding of previous attacks.

Techniques and mechanisms described herein provide for reduced computational complexity. The synthetic indicator is computationally efficient, which is important for conducting real-time analysis and online calculations, allowing the system to quickly respond to potential threats without significant resource overhead.

Techniques and mechanisms described herein provide for reduced analytic complexity. The synthetic indicator simplifies the analysis process by providing a single, easy-to-understand value. Security analysts or other evaluators can quickly compare the score against predefined thresholds to determine the likelihood of an attack, reducing the need for in-depth analysis of complex AI/ML outputs. This approach streamlines the workflow and allows for faster decision-making.

Techniques and mechanisms described herein provide for adaptive, rapid transition between offline and online DDoS monitoring and prevention. In some embodiments, a web application firewall may be maintained in an offline or monitoring-only state. Then, upon receiving an instruction generated by an orchestrator, the web application firewall may be activated for traffic monitoring. In this way, the delay and cost associated with employing a web application firewall for traffic monitoring and attack mitigation may be limited to situations in which such monitoring and attack mitigation is indicated. Such adaptive control may be applied to a variety of contexts, including configurations involving a public cloud provider, a first party cloud provider, a cloud-native web application firewall, a web application firewall implemented in a sidecar configuration, and/or other types of configurations.

Techniques and mechanisms described herein provide for an adaptive DDoS defense mechanism suitable for a multi-substrate architecture. Unlike conventional solutions that operate continuously in inline mode, various embodiments described herein employ an out-of-band approach. The system can remain passive during normal operations, thereby avoiding the latency and throughput penalties associated with traditional continuously operating inline methods. However, protection may be rapidly activated in response to a detected DDoS incident, ensuring robust protection without the typical drawbacks.

Various embodiments described herein may include one or more elements related to adaptive activation of application layer DDoS protection. For example, an out-of-band, reduced-capacity system may be deployed alongside the application. This system can be quickly scaled and transitioned from a “monitoring” mode to an “active” mode in response to a DDoS event. As another example, a DDoS detection mechanism may analyze traffic patterns, generating alerts upon identifying potential threats. As yet another example, an orchestrator component processes alerts generated by the DDoS protection mechanism and triggers the necessary system changes, including switching from monitoring to active mode and scaling the defense capabilities according to the traffic demands. For cloud-native services, this orchestrator can also activate the appropriate subscription-based protection services as needed.

In some embodiments, techniques and mechanisms described herein may facilitate effective DDoS protection in a shared infrastructure environment, where it can selectively target the attacked resources with minimal impact on the performance of other customers. Thus, various embodiments described herein may be particularly adaptive to multitenant computing services environments.

In some embodiments, by remaining inactive during normal operations, the system can avoid adversely affecting characteristics such as latency, throughput, and operational costs until a DDoS event occurs. Then, once the threat subsides, the system can revert to its original state, further optimizing resource use and performance. Thus, various embodiments described herein provide an adaptive, scalable, and cost-effective approach for DDoS, offering robust security without the typical performance trade-offs of traditional L7 application protection methods.

In some embodiments, techniques and mechanisms described herein provide for automated mitigation strategy formulation and implementation. The system can not only identify and evaluate threats but also autonomously formulate and execute mitigation strategies. Such strategies may involve dynamic adjustments to traffic handling and rate limiting based on the nature of the detected threat, without requiring manual intervention.

In some embodiments, techniques and mechanisms described herein provide for IP reputation assessment and heuristic analysis. Incorporating IP reputation data and heuristic analysis for evaluating the threat level of incoming traffic adds a layer of sophistication, enabling the framework to more effectively identify and prioritize threats based on their origin and behavior patterns.

In some embodiments, techniques and mechanisms described herein provide post-mitigation analysis and reporting. After action is taken, the system may automatically generate one or more comprehensive reports detailing the attack, the response actions taken, and/or recommendations for future improvements. Such an approach helps to provide for future learning and system enhancement without manual data compilation and analysis.

In some embodiments, techniques and mechanisms described herein facilitate attack detection and mitigation with minimal manual oversight. By significantly reducing the need for human intervention in the detection, analysis, and mitigation processes, the system offers a cost-effective, efficient, and less error-prone alternative to conventional solutions that depend heavily on cybersecurity teams.

In some embodiments, techniques and mechanisms described herein provide for an adaptive and scalable architecture. The system can adapt to evolving threats and scale as necessary to handle varying levels of traffic and attack intensity, providing flexibility and robustness unmatched by more static or manual solutions.

Consider the example of John, an IT professional at a cloud computing service provider providing computing services to various entities via the Internet. John is responsible for ensuring the robustness and security of the institution's digital infrastructure. One of his critical tasks is detecting and mitigating Layer 7 (L7) application layer DDoS attacks, which target the application layer to disrupt services by overwhelming them with malicious traffic. When using conventional approaches, John's efforts are complicated by the shared nature of the cloud computing provider's infrastructure. For instance, a DDoS attack may target only a single entity via a few ingress paths but may negatively affect services to multiple entities across the platform. Accordingly, John's efforts require significant manual intervention and risk negatively affecting the service of entities on the platform other than the targeted entity.

In contrast to conventional techniques, techniques and mechanisms described herein provide for an advanced L7 DDoS attack detection and mitigation system to streamline John's efforts. This system utilizes machine learning algorithms to analyze traffic patterns in real-time, distinguishing between legitimate user activity and potential threats. By providing detailed analytics and automated responses, the system allows John to swiftly identify and block malicious traffic without affecting access by legitimate users. The ability to configure specific thresholds and adaptive learning models means that the mitigation strategies evolve alongside emerging threats, significantly reducing downtime and enhancing the user experience. With this sophisticated tool, John can proactively protect the shared infrastructure from complex DDoS attacks, ensuring continuous service availability and strengthening the overall security posture. As used herein, the term “multiple” refers to two or more.

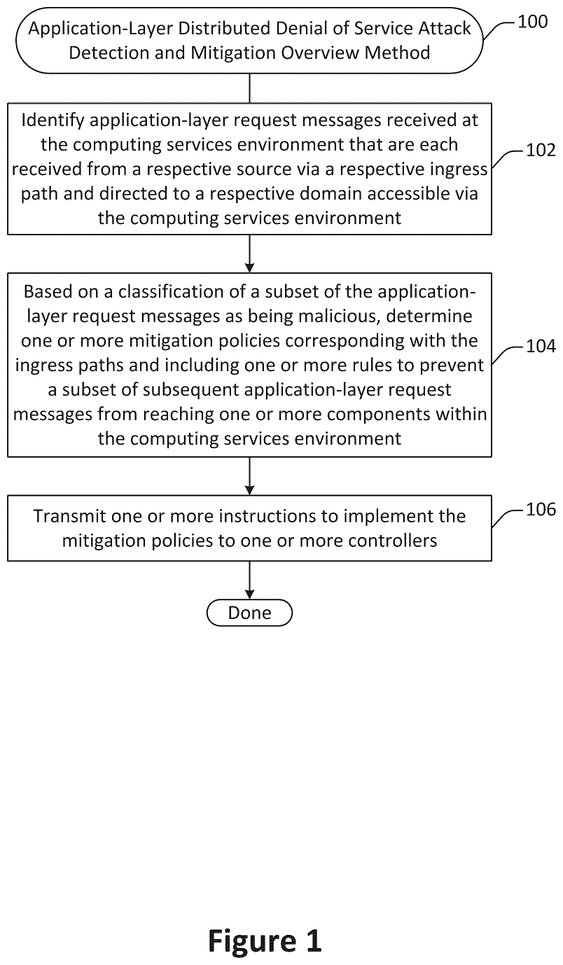

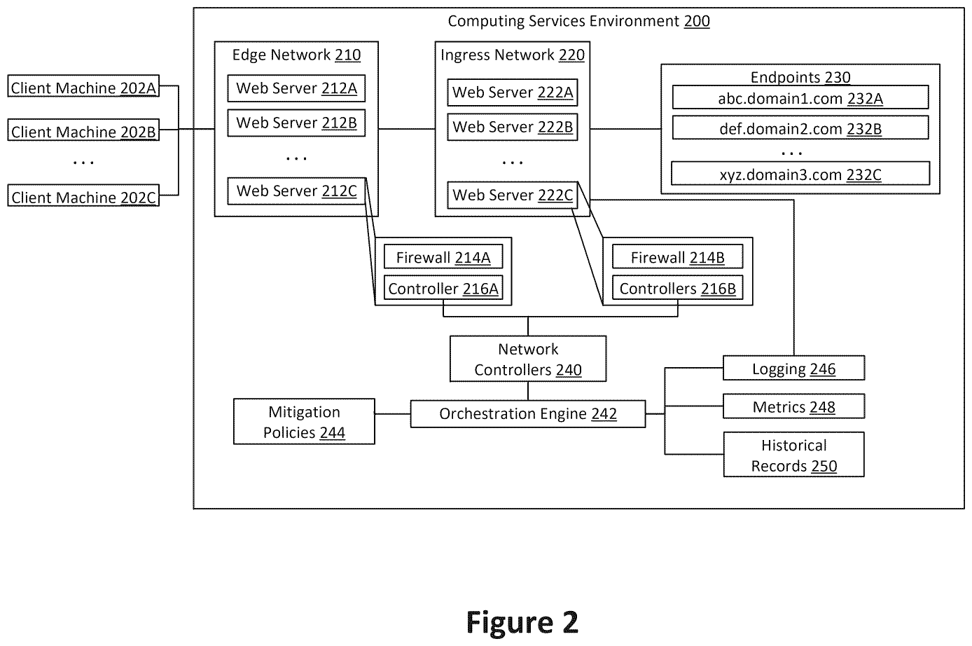

FIG. 1 illustrates an overview method 100 for application-layer distributed denial of service attack detection and mitigation, performed in accordance with one or more embodiments. According to various embodiments, the method 100 may be performed at a computing services environment such as the computing services environment 200 shown in FIG. 2. DDoS attacks may take place in a variety of ways including, and not limited to, spurious requests sent via a one or more client machines to one or more domains via one or more communication channels during one or more time-ranges.

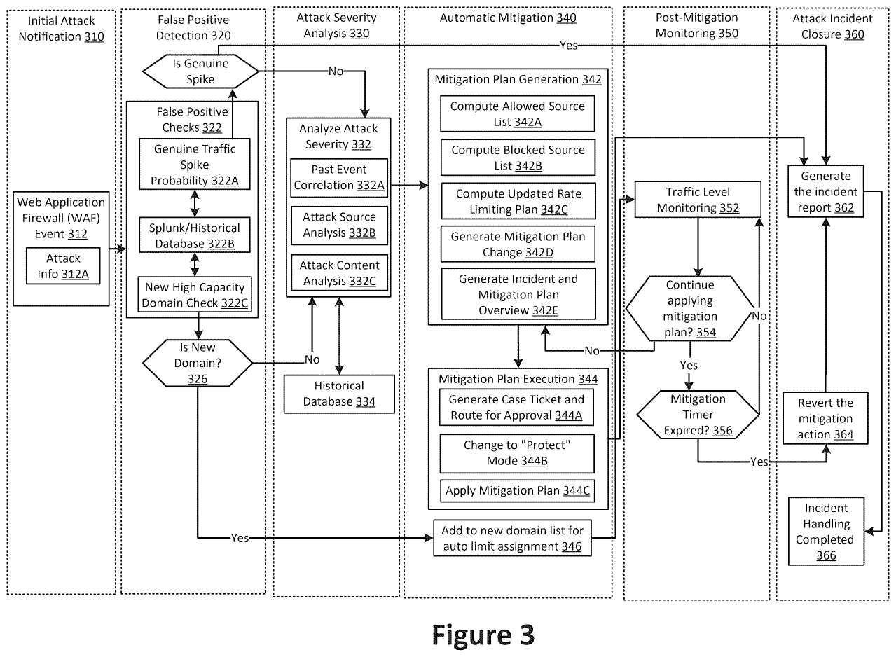

Application-layer request messages received at the computing services environment are identified at 102. The request messages are each received from a respective source via a respective ingress path and directed to a respective domain accessible via the computing services environment. In some embodiments, a given request message may be non-malicious. For example, a user may be attempting to log into their corporate email account from their work device. However, some request messages may instead be classified as malicious. For example, one or more client machines may be sending request messages to one or more domains to intentionally erode performance. Additional details regarding the identification of application-layer request messages received at the computing services environment are discussed with respect to the method 300 shown in FIG. 3.

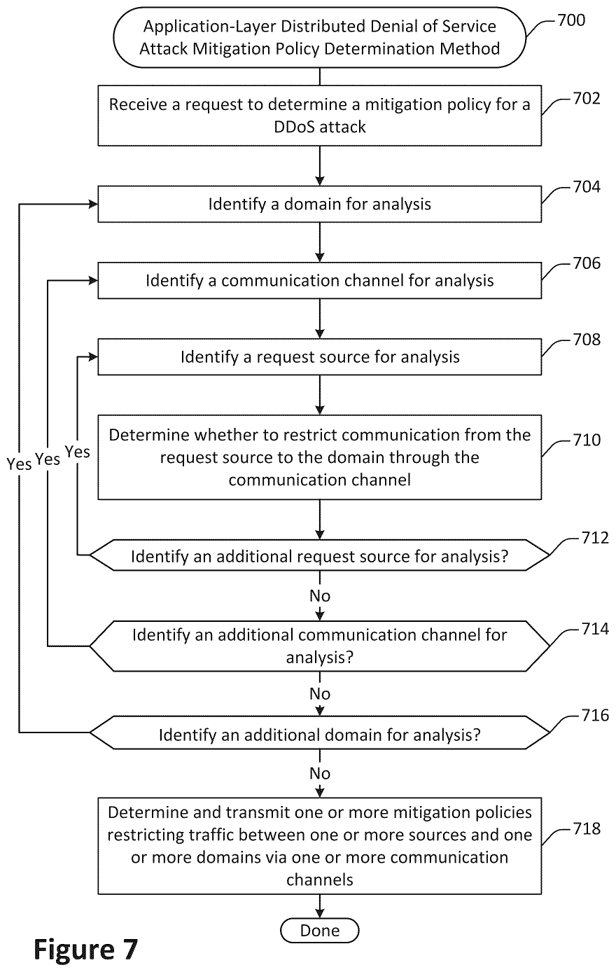

One or more mitigation policies are determined at 104. According to various embodiments, the policies are determined based on a classification of a subset of the application-layer request messages as being malicious. The mitigation policies may correspond with the ingress paths and include one or more rules to prevent a subset of subsequent application-layer request messages from reaching one or more components within the computing service environment. Mitigation policies may be determined by one or more techniques. For example, a determination process may include historical information on a domain endpoint. As another example, the mitigation policy may be determined by evaluating the performance of the selected mitigation policy and determining if modification need to be made. Additional details regarding the mitigation policy determination are discussed with respect to the method 700 shown in FIG. 7.

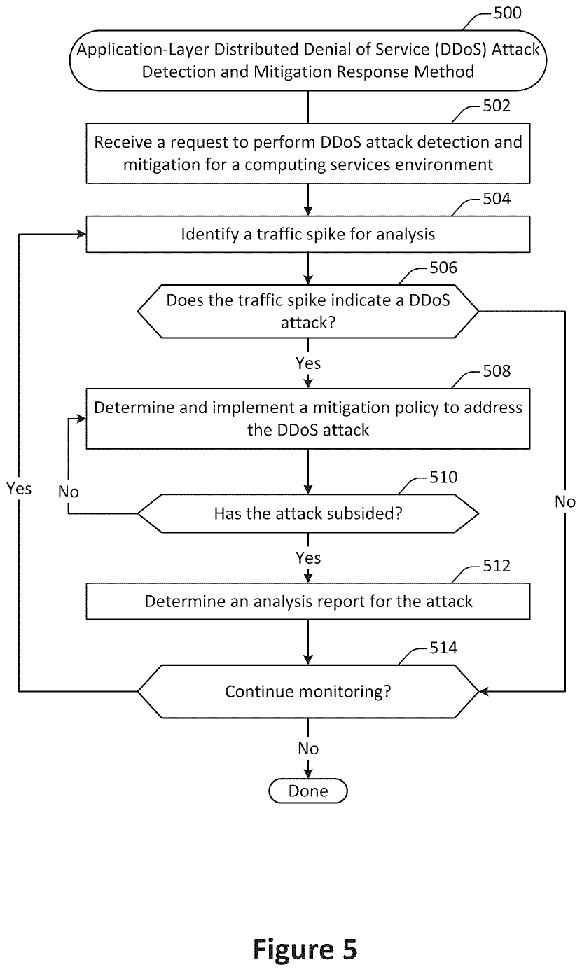

One or more instructions are transmitted to one or more controllers at 106. According to various embodiments, the instructions contain relevant information for implementing the mitigation policies at the controllers. For example, a mitigation policy that throttles the malicious traffic of a client-machine may instruct the one or more controllers to limit the malicious traffic that is being processed by the edge network. As another example, a mitigation policy may contain instructions to a controller to divert non-malicious traffic to a different webserver. Additional details regarding the implementation of the mitigation policy are discussed with respect to the method 500 shown in FIG. 5.

It should be noted that the method 100, as well as more generally other techniques and mechanisms described herein, may be applied to a portion of a computing services environment rather than to an entire computing services environment. For instance, traffic may be analyzed and attacks may be identified and mitigated on any of various levels. Such levels may include one or more of: one or more domains, one or more application servers, one or more geographic locations, one or more service types, one or more service recipients, one or more network ingress paths, one or more traffic sources, and/or any other element through which a computing services environment interacts with external machines to provide computing services.

### DDoS Mitigation Architecture

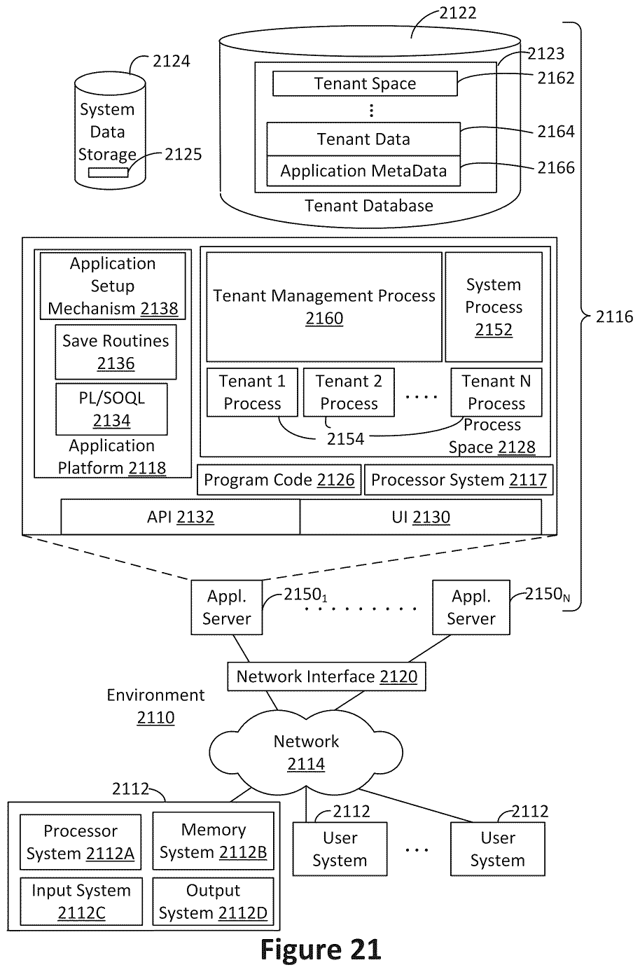

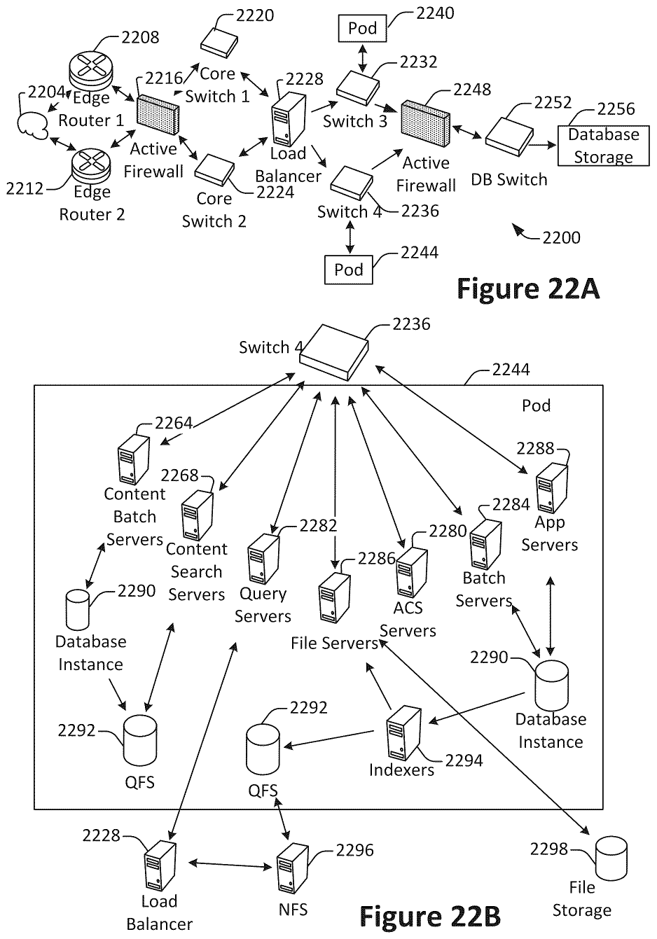

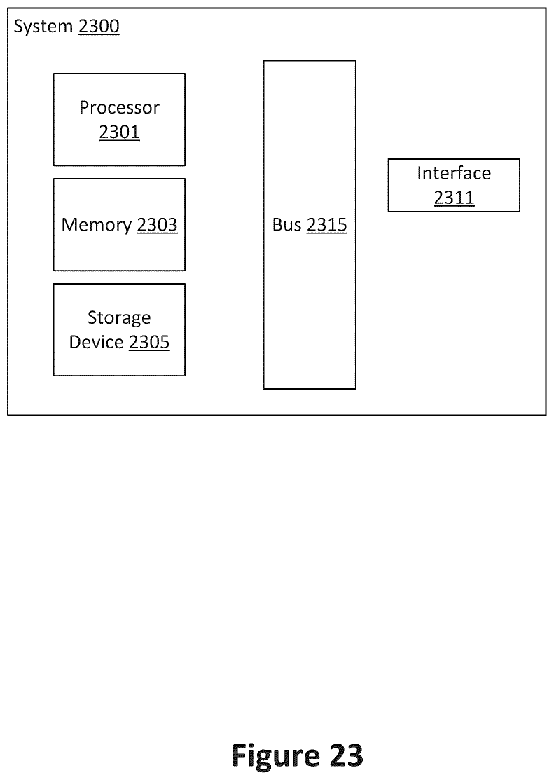

FIG. 2 illustrates one example of a computing services environment 200. According to various embodiments, the computing services environment 200 includes an edge network 210, an ingress network 220, a set of domain endpoints 230, network controllers 240, an orchestration engine 242, mitigation policies 244, a logging database 246, a metrics database 248, and historical records 250. The edge network 210 and ingress networks 220 contain one or more web servers depicted as edge network web servers (212A, 212B, and 212C) and ingress network web servers (222A, 222B, and 222C). The domain endpoints 230 containing one or more domain endpoints depicted as (232A, 232B, and 232C). Each web server contains a firewall 214, and a controller 216. The edge network webserver 212C includes a firewall 214A and a controller 216A, while the ingress network webserver 222C includes a firewall 214B and a controller 216B. Additional details regarding various elements that may be included in a computing services environment are discussed with respect to FIG. 21, FIG. 22A, FIG. 22B, and FIG. 23.

The one or more client machines (202A, 202B, and 202C) interact with one or more domain endpoints (232A, 232B, and 232C) via the computing services environment 200. In some embodiments, the interaction includes one or more client requests routed via a communication channel including a webserver (212A, 212B, and 212C) from the edge network 210, to the ingress network (220).

According to various embodiments, the edge network 210 receives one or more requests to access one or more domain endpoints from one or more client machines from across the internet. The edge network then routes the request traffic from the client machine to the appropriate web server in the ingress network to eventually reach the endpoint. However, a combination of client machines may instigate a DDoS attack on the computing services environment by intentionally sending spurious traffic to one or more domain endpoints. For example, malicious traffic may be caused by one or more cybersecurity attack techniques.

The edge network 210 includes one or more web servers (212A, 212B, and 212C). The web server 202 contains a firewall 214A and a controller 216A. Thus, the edge network may contain a separate layer of security. For example, a web server inside the edge network may contain a separate firewall to filter requests. As another example, the edge network may have a dedicated firewall filtering requests before they reach dedicated web servers that connect to the ingress network.

According to various embodiments, the ingress network 220 contains one or more webservers that connect to one or more domain endpoints 230. For example, the ingress network connects the requests sent from the client machines to one or more domain endpoints.

In some embodiments, the ingress network may contain a separate layer of security. For example, a web server inside the ingress network may contain a separate firewall to filter requests. As another example, the ingress network may have a dedicated firewall filtering requests before they reach dedicated web servers that connect to the domain endpoints.

In some embodiments, the ingress network 220 may be a separate network than the edge network. For example, in computing service environments with heavy traffic, a dedicated ingress network may manage the traffic from one or more client machines to one or more domain endpoints via one or more web servers in an edge network and via one or more web servers in an ingress network.

According to various embodiments, the domain endpoints 230 contains domain web addresses that may be accessible via the internet. One or more domain endpoints (232A, 232B, and 232C) are available in the domain endpoint set 230.

According to various embodiments, different domain endpoints may experience different traffic volumes. For example, a popular website may experience more traffic than a newly created website. As another example, a newly created website may experience more traffic than expected based on its popularity prior to launch.

In some embodiments, a domain endpoint may be a subdomain of a parent domain. For example, domain.com may be considered a parent domain to the child domain mail.domain.com.

According to various embodiments, the network controllers 240 may contain one or more controllers to update the controllers of one or more web servers in one or more networks. For example, the network controller may update the security of a web server based on a mitigation policy. As another example, the network controller may update one or more web server controllers to aid with the firewall protection depending on mitigation policies enacted by the orchestration engine.

In some embodiments, the network controllers may control the edge and/or ingress networks. For example, a mitigation policy may make amendments to a webserver in the ingress network. As another example, a mitigation policy may make amendments to the firewall of a web server in the edge network.

According to various embodiments, the orchestration engine 242 detects and mitigates any application-layer DDoS attacks via communication to one or more services. For example, the orchestration engine may communicate with one or more services from the logging database, metrics database, historical records, and the mitigation policies to aid with the detection and mitigation of application-layer DDoS attacks.

In some embodiments the orchestration engine 242 may include one or more services running on one or more machines working to detect and mitigate application-layer DDoS attacks. For example, having a dedicated service to detect attacks, a dedicated service to mitigate the attack, and a separate service to generate reports. As another example, the training and/or deployment of an artificial intelligence model may be done in a separate service. As yet another example, the orchestration engine may send a web server a mitigation policy via one or more of the network controllers 240.

According to various embodiments, the mitigation polices 244 may include policies to aid with the mitigation of application-layer DDoS attacks. For example, some mitigation policies may contain polices regarding the throttling traffic from one or more client machines, staggering traffic, re-directing traffic, adding client machine information to a list for future reference. As another example, a mitigation policy may add one or more client machine information to a block list to prevent future traffic from causing a DDoS attack.

According to various embodiments, the logging database 246 may store logging information from any element inside the computing services environment. For example, logs may contain relevant data such as client machine information, domain endpoints accessed, and duration of connection.

According to various embodiments, the metrics database 248 may contain any metrics that aid with the detection and mitigation of application-layer DDoS attacks. For instance, the metrics database may include data reflecting measured performance at one or more elements in the computing services environment.

According to various embodiments, the historical records 250 may contain any information required to detect and mitigate application-layer DDoS attacks. For example, historical information may be stored such as traffic spikes information, previous mitigation policies, mitigation policy success rate, and incident reports.

FIG. 3 illustrates an example of an overview flowchart 300 illustrating various operations performed in the course of identifying and mitigating an application-layer DDoS attack, configured in accordance with one or more embodiments. According to various embodiments, the overview diagram 300 includes the following phases: an initial attack notification phase 310, a false positive detection phase 320, an attack severity analysis phase 330, an automatic mitigation phase 340, a post-mitigation monitoring phase 350, and an attack incident closure 360 phase.

The initial attack notification phase 310, includes a Web Application Firewall (WAF) event 312. The WAF event may include information about the status of the web application firewall including any attack information 312A. In some embodiments, the attack information 312A includes information used to detect and mitigate an application-layer DDoS attack. For example, the attack information may include information about the client machine(s), endpoints domains, edge network, and ingress network. Additional details regarding the initial attack notification are discussed with respect to the method 500 shown in FIG. 5.

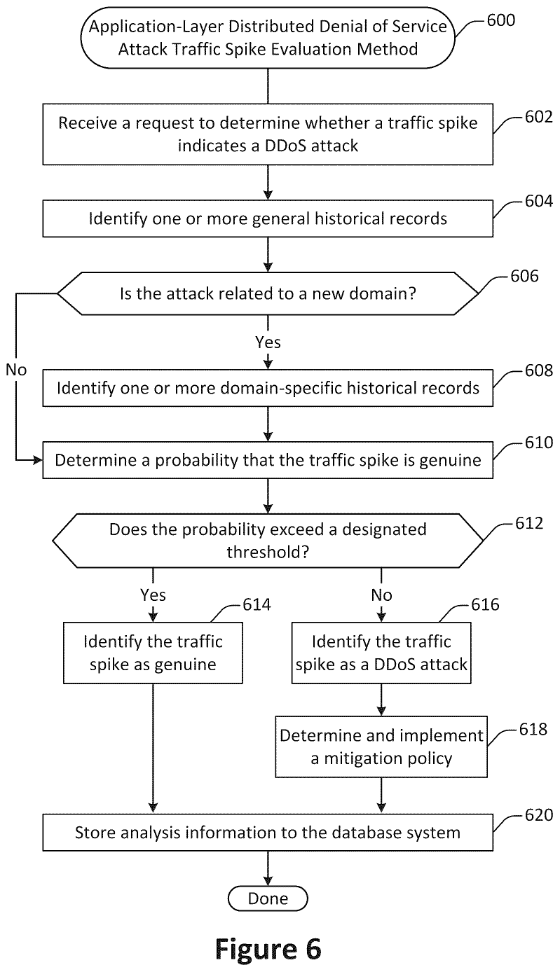

According to various embodiments, the false positive detection phase at 320 involves a false positive check at 322, a determination as to the genuineness of a traffic spike at 324, and a determination as to whether the traffic is related to a new domain 326. The false positive check at 322 may involve calculating the probability that the traffic spike is genuine at 322A, identifying one or more reference historical records at 322B, and/or performing a new high-capacity domain check 322C. Additional details regarding the false positive detection phase are discussed with respect to the method 600 shown in FIG. 6.

According to various embodiments, the attack severity analysis phase 330 may involve analyzing attack severity at 332 and/or communicating with the historical database 334. Analyzing attack severity at 332 may involve one or more of past event correlation 332A, attack source analysis 332B, and attack content analysis 332C. Additional details regarding the attack severity analysis are discussed with respect to the method 700 shown in FIG. 7.

According to various embodiments, the automatic mitigation phase 340 may involve one or more of the generation of a mitigation plan at 342, the execution of the mitigation plan at 344, and assigning a threshold for a new domain at 346. Additional details regarding such operations are discussed with respect to the method 600 shown in FIG. 6.

According to various embodiments, mitigation plan generation 342 may involve one or more of determining an allowed source list 342A, determining a blocked source list 342B, and/or determining an updated rate limiting plan 342C, generating a mitigation plan change 342D, and generating an incident and mitigation plan overview 432E. That is, mitigation plan generation may involve classification of the sources of messages.

In some embodiments, one set of sources may be classified as “bad”, or believed to be associated with malicious behavior. Bad sources may be identified based on any of a variety of information or characteristics. For example, a source associated with an internet protocol (IP) address that has been predetermined as being associated with malicious activities may be identified as bad. As another example, a source that requests access to various URLs that are not actually served by the computing services environment may be identified as bad. As yet another example, a source that repeatedly submits login requests that are rejected by the system may be identified as bad. As still another example, a source that accesses many different domains in a short period of time may be identified as bad. More generally, a source may be identified as bad by questionable behavior at the network layer, the transport layer, and/or the application layer of the Open Systems Interconnection model.

According to various embodiments, sources identified as bad may be blocked, at least temporarily, from sending future requests to one or more components of the computing services environment. For instance, a source identified as bad may be restricted from sending requests to an application via a mitigation policy imposed at an edge network and/or ingress network web server, at least for a period of time.

In some embodiments, one set of sources may be classified as “good.” Good sources may be those identified as having transmitted requests identified as normal. For example, a source that transmits a login request that successfully authenticates to the system may be identified as good. As another example, a source that transmits a small number of requests for URLs that are actually served by the computing services environment may be identified as good. More generally, source may be identified as good based on behavior at the network layer, the transport layer, and/or the application layer of the Open Systems Interconnection model.

In some embodiments, one set of sources may be classified as “unknown.” Unknown sources may be those for which insufficient information is available for a definitive classification. Initially, for instance at the beginning of a distributed denial of service attack, a potentially large portion of incoming requests may be received from sources classified as unknown. However, many such sources may be subsequently classified as either good or bad as more information becomes available.

In some embodiments, unknown sources may be subjected to rate limiting or other forms of traffic shaping. For instance, rate limiting for unknown sources may be increased in proportion to the severity of the distributed denial of service attack to help ensure that service can continue to be provided to sources identified as good. Additional details regarding such operations are discussed with respect to the method 700 shown in FIG. 7.

According to various embodiments, mitigation plan execution 344 may involve one or more of generating a case ticket and route for approval 344A, changing to “protect” mode 344B, and applying mitigation plan 344C. Additional details regarding mitigation plan execution are discussed with respect to the method 500 shown in FIG. 5.

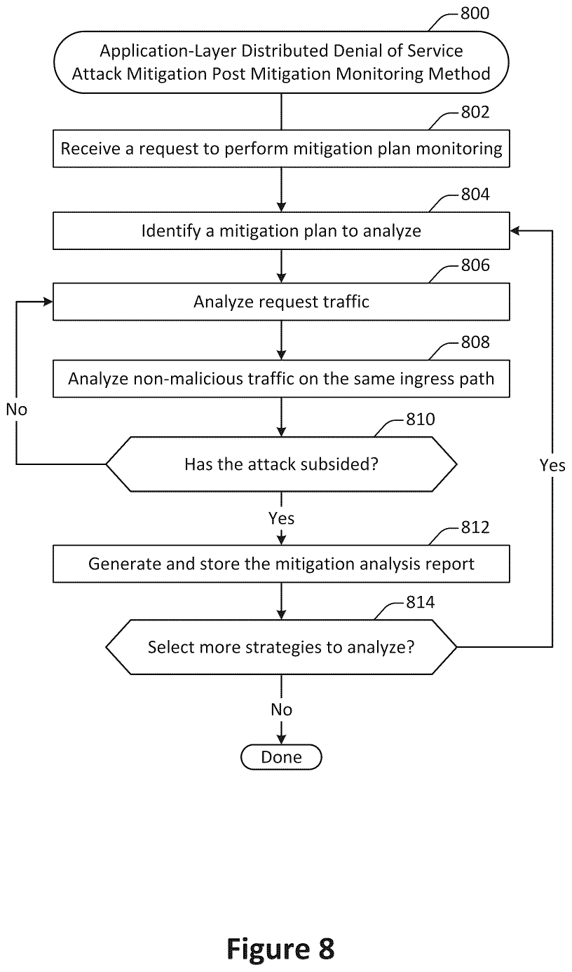

According to various embodiments, the post-mitigation monitoring phase 350 may involve traffic level monitoring 352, determining whether to continue applying mitigation plan 354, and determining whether to continue traffic level monitoring based on the expiration of the mitigation timer at 356. Additional details regarding post-mitigation strategy monitoring are discussed with respect to the method 800 shown in FIG. 8.

According to various embodiments, they attack incident closure 360 phase may involve one or more of generating an incident report 362, reverting the mitigation action at 364 based on the expiration of the migration timer 356, and completing incident handling at 366. Additional details regarding such operations are discussed with respect to the method 800 shown in FIG. 8.

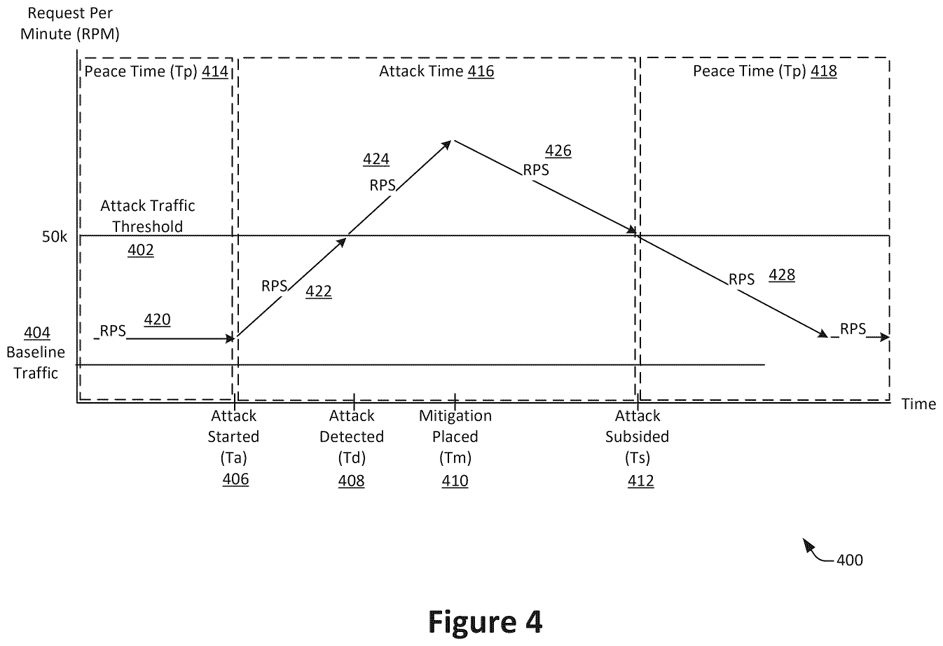

FIG. 4 illustrates one example of a response diagram 400, configured in accordance with one or more embodiments. According to various embodiments, the response diagram 400 depicts an example of a lifecycle of an L7 DDoS attack, including a peace time before an attack has started 414 followed by the time under which the DDoS attack is taking place 416 and a subsequent peace time 418. A sample attack traffic threshold is shown at 402, a baseline traffic level is shown at 404, and a line plotting requests per minute traffic is shown at 420, 422, 424, 426, and 428. The x-axis represents time and the y-axis represents request per minute for a given domain endpoint. The response diagram 400 may be determined based on information extracted from logs, metrics, historical data and may be used to visually represent the phases through which a hypothetical application-layer DDoS attack traverses.

A peace time phase is depicted at 414. According to various embodiments, the requests per minute 420 and the baseline traffic 404 does not exceed attack traffic threshold. The peacetime phase ends when the attack has started at 406.

An attack time phase is depicted at 416. The traffic begins to increase at 422 relative to the peacetime traffic 420. The attack started time 406 is the time the attack is estimated to have started based on when the traffic begins to increase due to the attack. The attack is detected at 408 when the traffic 422 exceeds the attack traffic threshold 402. The attack mitigation strategy generation method is executed when the attack is detected at 408, leading to the implementation of a mitigation plan at 410. After the mitigation plan is placed at 410, the traffic 426 reduces until the traffic has subsided at 412, when the traffic is below the attack traffic threshold 402.

A peace time phase is depicted at 418. According to various embodiments, the peace time phase occurs when the attack has subsided. The attack may be determined to have subsided when the traffic is below the attack traffic threshold 402. The traffic 428 may continue to decrease until it reaches levels similar to that of traffic 420, before the attack took place, or the baseline traffic at 404.

### DDoS Mitigation Processes

FIG. 5 illustrate a method 500 for detecting and mitigation an application-layer distributed denial of service attack, performed in accordance with one or more embodiments. According to various embodiments, DDoS attack detection and mitigation may involve operations such as determining if a traffic spike indicates a DDoS Attack, determining and implementing a DDoS mitigation policy, verifying if the attack has subsided, and determining an analysis report. The method 500 may be performed at the computing services environment 200 shown in FIG. 2, for instance at the orchestration engine 242.

A request to perform DDoS attack detection and mitigation for a computing services environment is received at 502. The request may be triggered depending on conditions occurring in other parts of the computing services environment 200. In some embodiments, the request may be triggered depending on the volume of traffic. For example, the request may be triggered whenever the traffic volume for a given set of domains exceeds threshold. As another example, the request may be triggered whenever a change in rate of traffic for a given set of domains exceeds a rate change threshold.

According to various embodiments, the request may be triggered depending on characteristics of the computing services environment 200. For example, one or more domains may be more prone to DDoS attacks. As another example, one or more channels may be particularly prone to DDoS attacks, for instance based on the resources available at a given time or the domains accessible via the one or more channels.

A traffic spike is identified for analysis at 504. A traffic spike may include traffic from one or more sources to one or more endpoints via one or more channel paths. In some embodiments, the traffic identified for analysis may include additional traffic. For example, traffic leading up to the traffic spike may also be identified for analysis.

According to various embodiments, some or all of the traffic may be identified for analysis. For example, some traffic, such as traffic predetermined as valid, may be filtered out when analyzing the traffic spike.

A determination is made at 506 as to whether the traffic spike indicates a DDoS attack. According to various embodiments, the classification of a traffic spike being a DDoS attack may involve one or more of various techniques. For example, non-malicious traffic may be filtered out. As another example, one or more data augmentation techniques may be employed, for instance to determine supplemental metadata characterizing the traffic. As another example, synthetic data may be generated to aid in the evaluation, for instance if suitable comparison data is limited.

In some embodiments, a traffic spike classification technique may involve using one or more artificial intelligence models (e.g. classification models) to classify some or all of the traffic. Alternatively, or additionally, traffic spike classification may involve historical information. For example, historical trends and/or previous traffic spike classifications may also aid with classification.

A mitigation policy to address the DDoS attack is determined and implemented at 508. According to various embodiments, the determination of a DDoS attack mitigation policy may involve one or more techniques, for instance techniques involving one or more artificial intelligence and/or machine learning models. For example, the mitigation policy may be determined by using machine learning to predict the probability of success for a mitigation policy. As another example, machine learning model may be used to classify the type of attack to improve the determination operation. As yet another example, a large language model may be used to generate some or all of the mitigation policy and/or a description of the mitigation policy.

In some embodiments, the implementation of the mitigation policy to address the DDoS attack may involve sending instructions to one or more network controllers. For example, upon receiving the mitigation policy, the network controllers may begin to throttle the traffic from one or more sources, ultimately mitigating the DDoS attack. As another example, the network controllers may include instructions from the mitigation policy to amend the firewall of a web server, ultimately mitigating the DDoS attack.

In some embodiments, the network controllers may implement some or all of the mitigation policy at a future point in time. For example, mitigation policy may include one or more instructions to execute at a predetermined time. Alternatively, or additionally, the network controllers may implement some or all of the mitigation policy upon receiving the policy.

A determination is made at 510, as to whether the attack has subsided. According to various embodiments, one or more of various techniques may be employed to evaluate if the attack has subsided. The traffic volume may be used as a metric to guide the determination. For example, the overall traffic volume may be compared against a threshold to determine if an attack has subsided. As another example, the reduction in traffic volume from one or more sources may also indicate the DDoS attack has subsided. As yet another example, the rate of change in traffic volume may also be used to determine if a DDoS attack has subsided.

An analysis report is determined for the attack at 512. The analysis report may contain relevant information about the DDoS attack, mitigation strategy, and other information to provide a holistic report. Some or all of the analysis report may be stored for future reference.

In some embodiments, the analysis report may be used to improve the determinations made by the orchestration engine 242. For example, the orchestration engine may interpret historical analysis reports to improve the determinations made during the mitigation strategy determination.

In some embodiments, the one or more analysis reports may be transmitted to appropriate entities. For example, one or more analysis reports may be transmitted to other services or to a human network administrator. As another example, one or more analysis reports may be transmitted to one or more entities accessing services via the computing services environment 200.

A determination is made at 514, as to whether to continue monitoring. In some embodiments, monitoring may continue until a request to cease monitoring has been received. Alternatively, or additionally, monitoring may continue until a DDoS attack has been successfully mitigated.

FIG. 6 illustrates method 600 of evaluating an application-layer distributed denial of service attack traffic spike, performed in accordance with one or more embodiments. The method 600 may be performed at the computing services environment 200 shown in FIG. 2, for instance at the orchestration engine 202. The classification of a traffic spike may involve operations such as identifying one or more historical records, determining the probability the spike is genuine, comparing the probability with a designated threshold, and storing relevant analysis information.

A request to determine whether a traffic spike indicates a DDoS attack is received at 602. In some embodiments, the request may contain relevant information necessary to determine whether a traffic spike indicates a DDoS attack. For example, the request may contain information about the source, channel information, traffic spike thresholds, and domains.

One or more general historical records are identified at 604. In some embodiments, historical records may be used to classify the some or all of the traffic spike as genuine or a DDoS attack. For example, if traffic reflected in one or more pre-classified historical records matches some or all of the traffic spike, then the traffic spike may be classified similarly.

In some embodiments, historical records related to the traffic spike may be also identified. For example, historical records related to one or more sources of the traffic spike may be used to aid with traffic spike evaluation.

A determination is made at 606 as to whether the attack is related to a new domain. In some embodiments, the determination may be made based on a length of time that the domain has existed within the computing services environment 200. For instance, a domain that has existed for less than a predetermined period of time, such as one week or one month, may be classified as “new”. Such a classification may help to determine the extent to which classification of the traffic spike is informed by historical records for the domain under analysis versus more general historical records covering various domains.

Upon determining that the attack is related to an existing domain, then one or more domain-specific historical records are identified at 608. In some embodiments, domain-specific historical records may include records about previous traffic spike evaluations. For example, domain-specific historical traffic spikes were determined to be genuine. If instead the attack is determined to not be related to an existing domain, then at 610 a probability that the traffic spike is genuine is determined. In some embodiments, the determination is made by looking up the domain associated with the traffic spike in the historical domain records.

In some embodiments, related domain-specific historical records may be identified when the domain is new. For example, if the new domain is an ecommerce website, related ecommerce website historical records are identified. As another example, if the new domain (e.g. mail.domain.com) is related to a main domain (e.g. domain.com) then the historical records of the main domain may be used instead.

Although the determination as to whether the domain is new is shown in FIG. 6 as being a binary determination, in practice the determination may be more continuous. For example, the more historical data is available for a given domain, the more such domain-specific historical data may be prioritized over more general historical data when evaluating traffic for the domain.

The probability that the traffic spike is genuine is determined at 610. According to various embodiments, the probability may be calculated in a variety of ways, including one or more techniques based in artificial intelligence, machine learning, and/or statistical analysis. For example, a machine learning classification model, logistic regression classifier model, linear probability model, or other such model may be pre-trained on historical data to classify traffic spikes as genuine or not based on previous classification information. In some configurations, an ensemble model combining various classifiers may be used.

According to various embodiments the probability the traffic spike is genuine may also be determined based on how much traffic the domain has received. For instance, newer domains have a higher probability of a traffic spike being genuine. Such information may be determined based on historical data and may be context specific, such as specific to particular industries or types of domains.

A determination is made at 612 as to whether the probability exceeded a designated threshold. In some embodiments, the confidence of the probability is also considered when determining the determination step. For example, given a machine learning model, if the confidence score of a traffic spike being classified as a DDoS attack is low, then the traffic spike may be initially identified as genuine and then reevaluated when new information becomes available.

Based on the determination made at 612, the traffic spike is identified as either genuine at 614 or a DDoS attack at 616. The identification of the traffic spike as a DDoS attack may trigger the determination and implementation of a mitigation policy at 618 as discussed with respect to the method 700 shown in FIG. 7.

Analysis information is stored on the database system at 620. According to various embodiments, the analysis information selected to be stored may include any relevant information created or determined during the traffic spike evaluation method. For instance, the analysis information stored may include information about the request received, any determinations made, and/or the traffic spike evaluation method.

According to various embodiments, the analysis information may also be referenced in part or full in related reports. For example, the traffic spike analysis report may be referenced in part or full in the mitigation analysis report. As another example, the traffic spike evaluation may also be used to train future models to improve the traffic spike evaluation method.

FIG. 7 illustrates method 700 of determining an application-layer distributed denial of service attack mitigation policy, performed in accordance with one or more embodiments. According to various embodiments, the DDoS attack mitigation policy determination may involve identifying a permutation of information containing a mixture of a domain, communication channel, and request source for which to restrict traffic, as well as any information about how traffic is to be restricted. The method 700 may be performed at the computing services environment 200 shown in FIG. 2, for instance at the orchestration engine 242.

A request to determine a mitigation policy for a DDoS attack is received at 702. The request may relevant information such as historical, source, timestamps, endpoint domain, channel, client machine(s), and any other relevant information required to determine a mitigation policy for a DDoS attack. The request may be generated as discussed with respect to the operation 618 shown in FIG. 6.

In some embodiments, a combination of potential DDoS attack signal combinations is selected to determine the attack mitigation policy. For example, a domain is identified for analysis at 704, a communication channel is identified for analysis at 706, and a request source is identified for analysis at 708. Such combinations may be identified an analyzed in parallel or in any suitable sequence.

A determination is made at 710, as to whether to restrict communication from the request source to the domain through the communication channel. In some embodiments, the determination may be made by using historical information. For example, the determination may use historical information about a given request source, communication channel, and/or domain to restrict communication. As another example, related historical information about a new domain may be used to determine whether to restrict communication.

In some embodiments, the determination to restrict communication from the request source to the domain through the communication channel may involve using a pre-determined threshold. For example, if the requests per minute for a given set of domains through a communication channel exceeds a threshold, traffic may be restricted. As another example, the threshold may be a variable threshold depending on, and not limited to, information such as domain, communication channel, request source, and time.

According to various embodiments, the determination to restrict communication from the request source to the domain through the communication channel may involve using one or more artificial intelligence models. For example, a machine learning model trained on historical data may be used to determine whether traffic from a particular source to a particular domain via a particular communication channel is genuine.

Upon determining whether to restrict communication channel from a request source to a domain via a communication channel, the analysis process may continue by determining if other combinations should be selected. A determination is made at 712, as to whether to identify an additional request source for analysis. A determination is made at 714, as to whether to identify an additional communication channel for analysis. A determination is made at 716, as to whether to identify an additional domain for analysis. As discussed herein, such combinations may be identified an analyzed in parallel or in any suitable sequence.

One or more mitigation policies are determined and transmitted at 718. The mitigation policies may involve restricting traffic between one or more sources and one or more domains via one or more communication channels.

According to various embodiments, the one or more mitigation policies may be transmitted to one or more of the network controllers 240 shown in FIG. 2. For instance, a mitigation policy may be transmitted to a network policy response for controlling a network component to which the mitigation policy applies.

In some embodiments, traffic may be blocked completion. For example, traffic from a particular source to a particular domain via a particular channel may be blocked at the edge network and/or ingress network level.

In some embodiments, a mitigation policy may throttle the traffic from the source flowing through the communication channel to the domain endpoint. For example, the mitigation policy may add a timeout feature to increase the time between requests from one or more sources to one or more domains via one or more communication channels.

In some embodiments, the mitigation policy may contain a mitigation policy timer. For example, if the mitigation policy timer has expired, then the mitigation may be reverted.

In some embodiments, the mitigation policy may divert traffic flowing through a given communication channel. For example, the mitigation policy may specify diverting non-malicious traffic to one or more communication channels. As another example, the mitigation policy may allow traffic for a certain timeframe before diverting all traffic to one or more communication channels. Diverted traffic may later be re-diverted back to the initial communication channel depending on the effectiveness of the mitigation policy.

According to various embodiments, a mitigation policy may be specific to one or more of: one or more domains, one or more traffic sources, and/or one or more network ingress paths. For example, a mitigation policy may block or redirect traffic via a particular network ingress path without necessarily being specific to a domain or a traffic source. As another example, a mitigation policy may block or redirect traffic from a traffic source to a domain without being specific to a particular network ingress path. Various combinations are possible.

FIG. 8 illustrates an application-layer distributed denial of service attack mitigation post mitigation monitoring method 800, performed in accordance with one or more embodiments. According to various embodiments, the DDoS attack mitigation analysis monitoring may involve analyzing the request traffic post DDoS policy enactment to evaluate the effectiveness of the mitigation policy on the given attack. The method 800 may be performed at the computing services environment 200 shown in FIG. 2, for instance at the orchestration engine 242.

A request to perform mitigation plan monitoring is received at 802. In some embodiments, the request may contain relevant information such as mitigation strategy, mitigation timeout timer, source, timestamps, endpoint domain, channel, client machine(s), and any other relevant information required to determine or monitor a mitigation policy for a DDoS attack. The request may be generated after the completion of the method 700 shown in FIG. 7.

A mitigation plan to analyze is identified at 804. The mitigation plan may be determined as discussed with respect to the method 700 shown in FIG. 7. In some embodiments, the efficacy of the mitigation strategy may be analyzed at any time after applying the mitigation plan. For example, a mitigation plan may be analyzed while its mitigation timer has not expired. As another example, the mitigation plan may be analyzed for comparison against other mitigation plans to determine an improved plan.

Request traffic is analyzed at 806. In some embodiments, the request traffic may be analyzed to determine the efficacy of the mitigation strategy. For example, the request traffic may be analyzed to determine if the overall traffic volume has changed since the mitigation plan was applied. As another example, the request traffic may be analyzed so to determine if traffic from particular sources to particular domains via particular communication channels has changed since the mitigation plan was implemented.

Non-malicious traffic on the same ingress path is analyzed at 808. In some embodiments, the non-malicious traffic may be monitored to validate that traffic from non-malicious sources continues to function as intended. As another example, non-malicious traffic may be monitored to verify that a mitigation strategy that involves diverting non-malicious traffic to a different ingress path is functioning as intended.

A determination is made at 810, as to whether the attack has subsided. In some embodiments, the determination is made by inspecting the traffic volume at one or more time ranges. For example, overall traffic volume may be compared with the DDoS traffic threshold. As another example, the amount of traffic originating from the source machines subject to the mitigation policy may be evaluated. For instance, determining if a DDoS attack has subsided may involve verifying that the traffic from the malicious client machines has decreased.

The mitigation analysis report may be generated and stored at 812. In some embodiments, generating the mitigation analysis report may involve operations such as comparing the results, storing the mitigation analysis, and/or generating a description of the results.

According to various embodiments, generating the mitigation analysis report may involve comparing the mitigation strategy against a simulation. For example, the mitigation strategy traffic volume may be compared to an expected traffic volume. As another example, the mitigation strategy traffic may be analyzed to determine the efficacy of the strategy in terms of time elapsed for attack mitigation.

Any relevant information generated by the analysis may be stored. In some embodiments, the mitigation analysis results may be stored to determine future mitigation strategies. For example, stored analysis may be used to determine a future mitigation strategy based on the effects the mitigation strategy had on the traffic. As another example, the stored analysis may be used to generate aggregate reports.

In some embodiments, a mitigation analysis report may be generated based on an interaction with a generative language model. For instance, a generative language model may be provided with information about an attack, a mitigation policy, and/or the performance of a mitigation policy in a prompt, along with one or more natural language instructions to generate a report based on the information. The generative language model may then complete the prompt with novel text that characterizes the information. Such text may then be stored and/or provided to one or more recipients. For instance, the report may be sent to an organization accessing computing services via the computing services environment and which may have been affected by the L7 DDoS attack.

A determination is made at 814, as to whether to select more strategies to analyze. In some embodiments, multiple strategies may be analyzed depending on the complexity of the DDoS attack. For example, given a complex DDoS attack from a variety of sources that continuously change, one or more mitigation policies may need to be applied that handle some or all of the affected DDoS attack traffic.

### Dynamic WAF Control Overview and Architecture

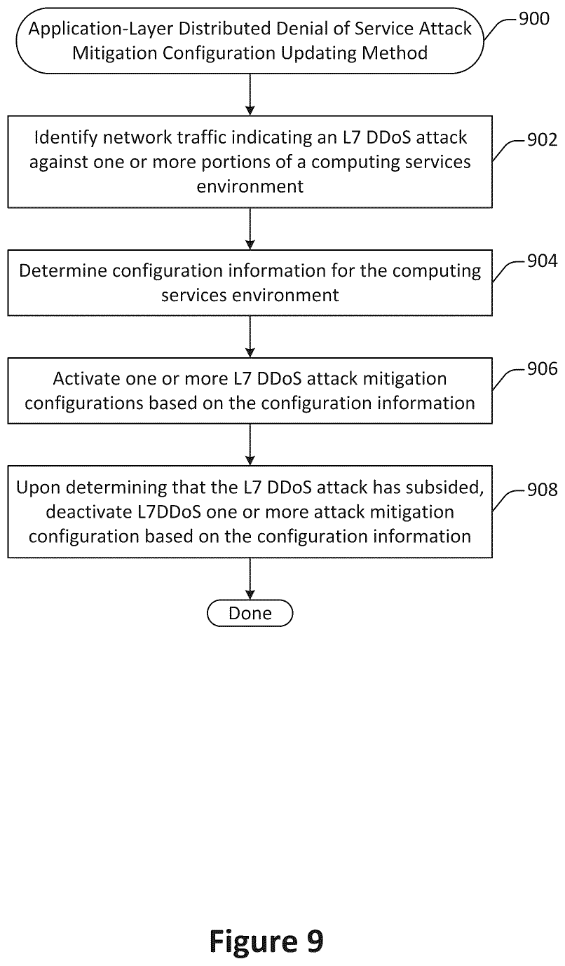

FIG. 9 illustrates an overview method 900 for application-layer distributed denial of service attack mitigation configuration. According to various embodiments, an L7 DDoS attack can be mitigated by updating, via a cloud controller, a cloud-provided WAF configuration to filter out malicious traffic. Such a process may depend on the particular type of network architecture employed in an ingress route.

In some embodiments, the method 900 may be performed at one or more components of a computing services environment such as the computing services environment 200 shown in FIG. 2. For instance, the method 900 may be performed at least in part at the orchestration engine 242.

Network traffic indicating an L7 DDoS attack against one or more portions of a computing services environment is identified at 902. According to various embodiments, some DDoS attacks may target one or more components of a computing services environment. For example, a DDoS attack may simultaneously send malicious traffic to a login page and the support page. As another example, a DDoS attack may target a new endpoint by sending requests from a variety of entry points into the edge network. Additional details regarding the detection of malicious traffic are discussed with respect to FIG. 3, FIG. 4, and FIG. 6.

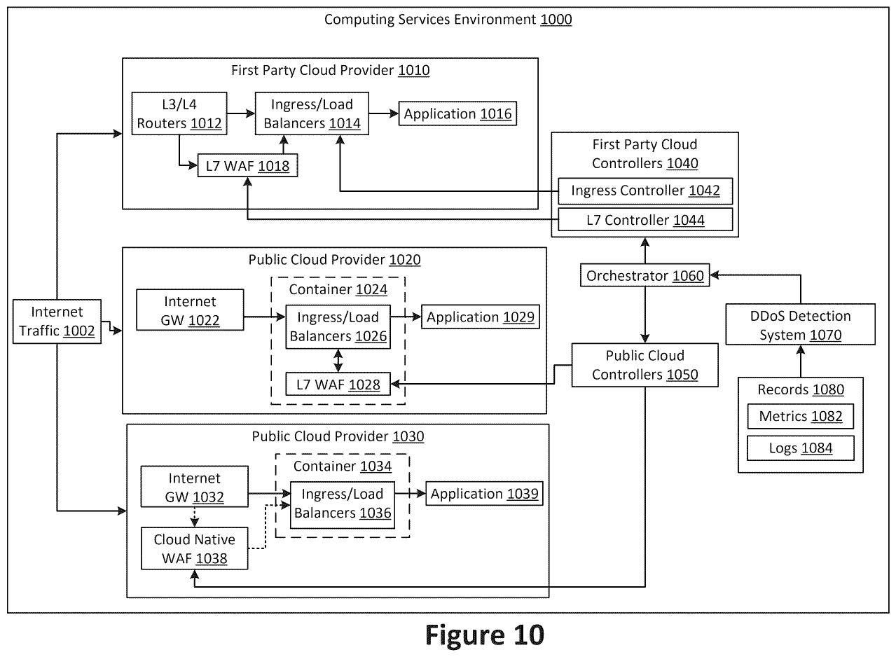

Configuration information is determined at 904 for the computing services environment. According to various embodiments, the computing services environment may contain one or more cloud provider solutions. For example, the computing services environment may contain a first party cloud provider for a subset of their endpoints, and a public cloud provider for a subset of their endpoints. As another example, the computing services environment may include a public cloud provider with a cloud-native WAF and an L7 WAF. As yet another example, the computing services environment may contain a first party cloud provider with an L7 WAF and an ingress/load balancer WAF, a public cloud provider with a cloud native WAF and an L7 WAF for the virtual environment. Additional details regarding various configurations of different components of a computing service environment with cloud providers are discussed with respect to FIG. 10.

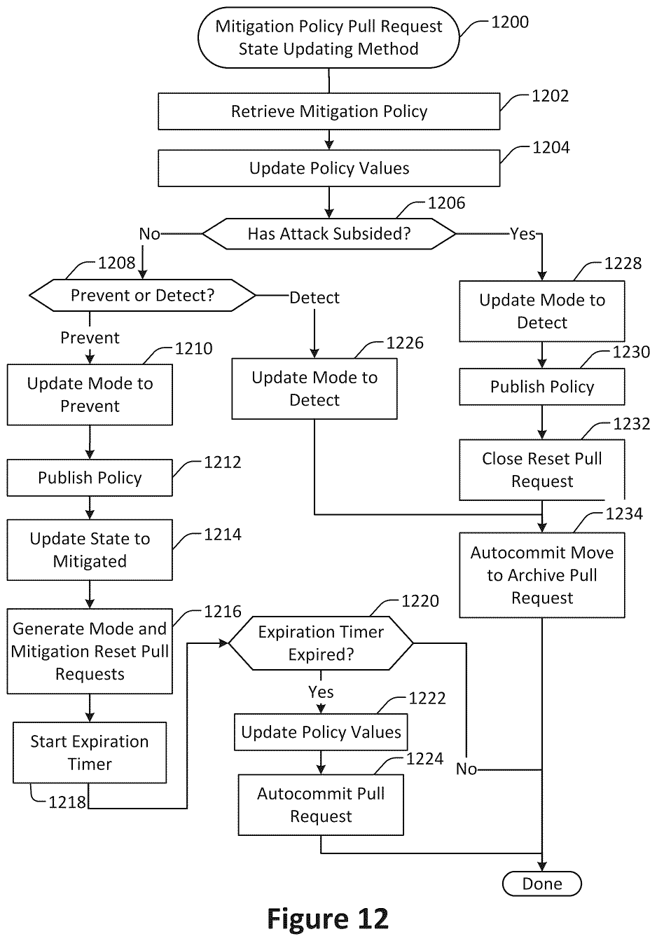

One or more L7 DDoS attack mitigation configurations are activated at 906 based on the configuration information. According to various embodiments, one or more attack mitigation configurations may be activated based on one or more configurations and will remain active until the attack has been confirmed to have subsided. For example, the L7 DDoS attack mitigation configuration may include information about the WAF state, attack information, and/or an updated mitigation policy. Additional details regarding the activation of attack mitigation in a WAF are discussed with respect to the method 1200 shown in FIG. 12.

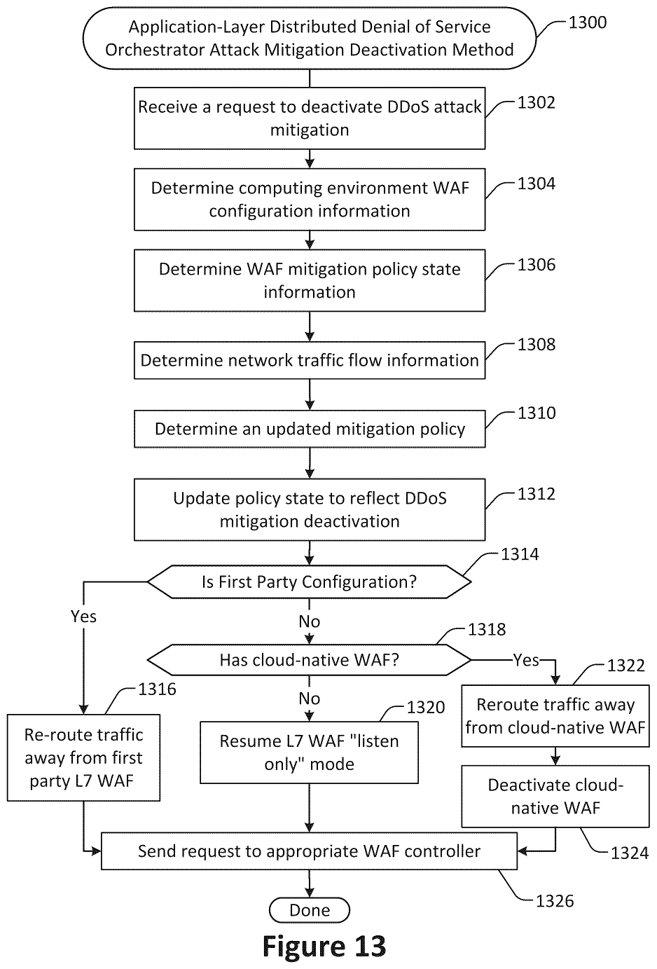

One or more L7 DDoS attack mitigation policies are deactivated at 908 based on configuration information. The L7 DDoS attack mitigation may be deactivated after determining the attack has subsided. In some embodiments, the deactivation request may be triggered depending on the volume of traffic. For example, the deactivation request may be triggered whenever the traffic volume for a given set of domains falls below the threshold. As another example, the deactivation request may be triggered whenever a change in rate of traffic for a given set of domains falls below a rate change threshold. Additional details regarding the deactivation of attack mitigation in a WAF are discussed with respect to the method 1300 shown in FIG. 13.

FIG. 10 illustrates one example of a computing services environment 1000, configured in accordance with one or more embodiments. The example computing services environment 1000 may be part of, or entirely within, the computing services environment 200 shown in FIG. 2. The computing services environment 1000 may be configured so as to facilitate rapid and adaptive deployment of DDoS attack mitigation when an application layer DDoS attack is detected.

The computing services environment 1000 includes internet traffic 1002, a first party cloud provider 1010, public cloud provider (1020 and 1030), first party cloud controllers 1040, public cloud controllers 1050, orchestrator 1060, DDoS Detection System 1070, and records 1080. The first party cloud provider 1010 contains L3/L4 routers 1012, ingress/load balancers 1014, application 1016, and L7 WAF 1018. The public cloud provider 1020 contains an internet gateway 1022, a virtualization container 1024, ingress/load balancers 1026, L7 WAF 1028, Application 1029. The public cloud provider 1030 contains an internet gateway 1032, cloud native WAF 1034, a virtualization container 1034, internet gateway 1038, Application 1039. The first party cloud controllers 1040 contain an ingress controller 1052, and L7 controller 1054. The records 1080 contains metrics 1082 and logs 1084. Additional details regarding various elements that may be included in a computing services environment 1000 are discussed with respect to FIG. 2, FIG. 21, FIG. 22A, FIG. 22B, and FIG. 23.

According to various embodiments, the internet traffic 1002 includes traffic from one or more client machines to one or more end points contained in the applications 1016, 1029, and/or 1039. For example, an endpoint may involve accessing a particular website (e.g. acme.domain.com). Alternatively, or additionally, an application (1016, 1029, 1039) may include endpoints not directly accessible by one or more client machines from the internet. For example, an authentication service may ping another service to validate the user signing into a webpage. As another example, an endpoint may only be accessed when connected to a certain network (e.g. intranet). Additional details regarding endpoints are discussed with respect to element 230 of FIG. 2.

According to various embodiments, the orchestrator 1060, in connection with the DDoS detection system 1070, detects and mitigates application-layer DDoS attacks via communication to one or more services. For example, the orchestration engine may communicate with one or more services from the logging database, metrics database, historical records, and the mitigation policies to aid with the detection and mitigation of application-layer DDoS attacks. The orchestrator may then instruct one or more first party cloud controllers and/or one or more public cloud controllers 1050 to initiate DDoS attack mitigation.

In some embodiments the DDoS detection system 1070 may include one or more services running on one or more machines working to detect and mitigate application-layer DDoS attacks. For example, having a dedicated service to detect attacks, a dedicated service to mitigate the attack, and a separate service to generate reports. As another example, the training and/or deployment of an artificial intelligence model may be done in a separate service. As yet another example, the orchestration engine may send a web server a mitigation policy via one or more of the first party cloud controllers 1040 and/or the public cloud controllers 1050.

According to various embodiments, the records 1080 may contain any information required to detect and mitigate application-layer DDoS attacks. For example, historical information may be stored such as traffic spikes information, previous mitigation policies, mitigation policy success rate, and incident reports.

According to various embodiments, the metrics database 1082 may contain any metrics that aid with the detection and mitigation of application-layer DDoS attacks. For instance, the metrics database may include data reflecting measured performance at one or more elements in the computing services environment.

In some implementations, the logging database 1084 may store logging information from any element inside the computing services environment. For example, logs may contain relevant data such as client machine information, domain endpoints accessed, and duration of connection.

According to various embodiments, the first party cloud controllers 1040 may contain one or more ingress controllers 1042 and L7 controllers 1054 to reroute the traffic of one or more web servers in one or more networks. For example, the first party cloud controllers 1040 may update the firewall of a web server based on a mitigation policy. As another example, the first party cloud controllers 1040 may update one or more web server controllers to aid with the firewall protection depending on mitigation policies enacted by the orchestration engine. Additional details regarding the types of network traffic modifications made by the first party cloud controllers 1040 are discussed with respect to method 1200 in FIG. 12 and method 1300 in FIG. 13.

In some embodiments, the ingress controller 1052 may control the ingress network (ingress/load balancers 1014). For example, a mitigation policy may make amendments to one or more webservers in the ingress network. As another example, a mitigation policy may make amendments to the firewall of a web server in the ingress network to prevent certain traffic from accessing a particular endpoint.

In some embodiments, the L7 controller 1044 may control the L7 WAF 1018 and other computing elements inside the first party cloud provider 1010. For example, a mitigation policy may make amendments to route all the outgoing traffic of the L3/L4 Routers 1012 to the L7 WAF 1018 and the L7 WAF filtering out the malicious traffic when sending traffic requests to the ingress/load balancers 1014.

According to various embodiments, the first party cloud provider 1010 receives requests to access one or more domain endpoints from one or more client machines from across the internet. The first party cloud provider 1010 may be a software and hardware solution deployed by the service provider of the computing services environment 1000. For example, a first party cloud provider is Salesforce for services and users of the Salesforce system.

According to various embodiments, the ingress/load balancers 1014 may contain one or more servers that connect one more client machines with one or more applications 1016. The first party cloud provider 1010 may include one or more L3/L4 routers 1012 that receive, filter, and route the traffic to the ingress/load balancers 1014.

In some embodiments, by adjusting the configuration of the L3/L4 routers 1012, the L7WAF may be adaptively configured to process or not process the incoming traffic. For example, when an attack has not been detected, the ingress/load balancers 1014 may process traffic received from the L3/L4 routers 1012 irrespective of any operations performed by the L7 WAF 1018. However, when attack mitigation is in place, the ingress/load balancers 1014 may delay forwarding to the application 1016 until the traffic has been filtered by the L7 WAF 1018.

According to various embodiments, when deployed, the L7 WAF 1018 may be instructed to inspect traffic entering the ingress/load balancers 1014. For example, the L7 WAF may be instructed to filter out malicious traffic before it reaches the ingress/load balancers 1014. As another example, the L7 WAF may block certain client machines from accessing the application 1016.

According to various embodiments, the public cloud provider (1020 and 1030) receives one or more requests to access one or more domain endpoints from one or more client machines from across the internet. The public cloud provider (1020 and 1030) may be a software and/or hardware solution involving resources external to the service provider of the computing services environment 1000. For example, service provider such as Salesforce may employ hardware resources provided by a public cloud provider such as Amazon Web Services (AWS) to provide the computing services.

In some embodiments, a public cloud provider may provide a cloud hosting solution that the client may use to filter the traffic being received on their network. The public cloud provider may also host virtual containers that can host one or more applications (e.g., 1029, 1039).

According to various embodiments, the internet gateways (1022 and 1032) of a public cloud provider (1020 and 1030) receive, filter, and route traffic to other servers to handle the traffic. The ingress/load balancers (1026, 1036) may perform similar tasks to the internet gateways (1022 and 1032) but may forward the traffic to a virtual environment/container for further processing. Once processed, traffic may be routed to an application (1029, 1039), which may be hosted on a public cloud provider and may be running in a virtual container.

According to various embodiments, a virtualization container (1024 and 1034) in a public cloud (1020 and 1030) automates the deployment, scaling, and management of containerized applications. The virtual container may be provided as a solution from the same or different organization than the public cloud provider (1020 and 1030). For example, a container service may be a Kubernetes cluster such as the one provided by Amazon Elastic Kubernetes Service (EKS) running on AWS.

According to various embodiments, a public cloud provider may provide one or more WAF solutions and APIs to make modifications to the WAF. For example, a public cloud provider may provide a native WAF 1038. The cloud native WAF 1038 may reside in a deactivated state when an attack has not been detected. Then, when an attack is detected, the cloud native WAF 1038 may be activated and used for traffic filtering. Upon activation, traffic may be rerouted from the internet gateway 1032 to the cloud native WAF 1038 before being sent to the ingress/load balancers 1036. The configurations of an L7 WAF 1028 may be updated by an API provided by the public cloud provider.

In some embodiments, a public cloud provider may support a user-deployed L7 WAF 1028. For instance, the user-deployed L7 WAF 1038 may be deployed in a Kubernetes sidecar configuration. The L7 WAF 1028 receives traffic requests from the ingress/load balancers 1026. When an attack has not been detected, traffic may continue to be processed by the ingress/load balancers 1026 regardless of operations performed by the L7 WAF 1028. However, when attack mitigation is in place, the ingress/load balancers 1026 may instead be configured to delay sending traffic to the application 1029 until the L7 WAF 1028 transmits a response approving the traffic. In this way, the L7 WAF 1028 may selectively filter traffic for the ingress/load balancers 1026. The ingress/load balancers (1014, 1028, 1036) are alternatively referred to herein as application gateways.

According to various embodiments, the public cloud controllers 1050 may contain one or more public cloud controllers to update the configuration of a WAF in the public cloud. Updating the public cloud WAF is done by an API. For example, the network controllers may update the security of a web server based on a mitigation policy. As another example, the network controller may update one or more web server controllers to aid with the firewall protection depending on mitigation policies enacted by the orchestration engine. Additional details regarding the types of network traffic modifications made by the first party cloud controllers 1040 are discussed with respect to method 1200 in FIG. 12 and method 1300 in FIG. 13.

The computing services environment 1000 shown in FIG. 10 is an example provided for the purposes of illustration. For instance, the computing services environment 1000 includes one each of a first party cloud provider 1010, a public cloud provider 1030 with a cloud-native WAF, and a public cloud provider 1030 with a WAF configured as a Kubernetes sidecar. However, in practice a computing services environment may have various numbers and combinations of cloud providers, WAF configurations, network architectures, and the like.

It should be noted that in the example shown in FIG. 10, not all of the hardware components are under the control of a single service provider. For example, the service provider of the computing services environment 1000 may deploy processes and data to provide computing services via hardware provided by other cloud computing service providers. Such a configuration may be referred to herein as a “public cloud” architecture.

### Dynamic WAF Control Management

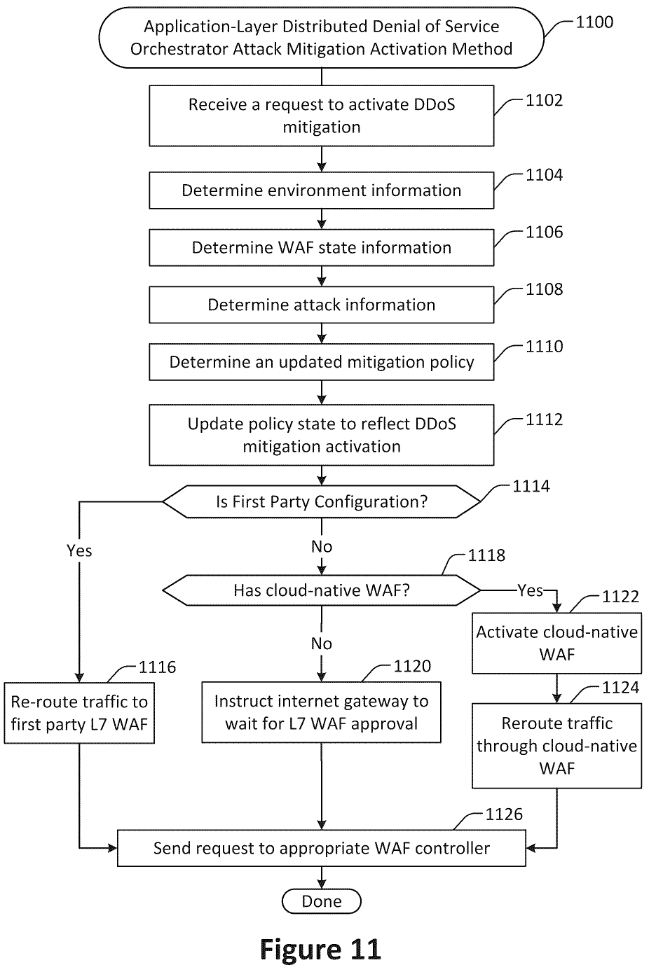

FIG. 11 illustrates a method 1100 of application-layer distributed denial of service orchestrator attack mitigation activation, performed in accordance with one or more embodiments. The attack mitigation activation method may be performed to relevant information based on the computing services environment and the DDoS attack information. The information may then be used to update a policy state to communicate with the appropriate WAF to filter out the malicious traffic. The method 1100 may be performed at the orchestrator 1060 shown in FIG. 10.

A request to activate DDoS mitigation is received at 1102. According to various embodiments, the DDoS mitigation request may be sent by the DDoS Detection System 1070. For example, an alert is sent to the orchestrator by the DDoS Detection System to reflect a DDoS attack that has been identified. Additional details regarding the detection of a DDoS attack are discussed with respect to the method 500 shown in FIG. 5.

Computing services environment information is determined at 1104. According to various embodiments, the computing services environment may contain one or more cloud provider solutions. For example, a computing services environment may contain a first party cloud provider for one subset of endpoints and a public cloud provider for another subset of endpoints. As another example, the computing services environment may include a public cloud provider with a cloud-native WAF and an L7 WAF. As yet another example, the computing services environment may include a first party cloud provider with an L7 WAF and an ingress/load balancer WAF, and a public cloud provider with a cloud native WAF and an L7 WAF for the virtual environment. As discussed with respect to FIG. 10, various configurations are possible.

In some embodiments, a validation operation may be performed to verify the health of all the components of the computing services environment are as expected. For example, the orchestrator may verify it can communicate with the cloud controllers and their respective WAFs. As another example, the orchestrator may authorize the cloud controllers to communicate with the respective WAFs.

WAF state information is determined at 1106. According to various embodiments, the orchestrator may gather the WAF state information. For example, the orchestrator may communicate with the cloud controllers to gather the type of state the WAF is currently in based on prior policies. The orchestrator may update any default values based on the WAF state. If indicated, the orchestrator may communicate with the cloud controllers to reboot the respective WAF.

Attack information is determined at 1108. According to various embodiments, the attack information may be gathered by one or more resources. For example, the attack information may be passed in as part of the request to activate the DDoS mitigation. As another example, the orchestrator may communicate with the DDoS Detection System to gather attack information.

An updated mitigation policy is determined at 1110. According to various embodiments, the mitigation policy is determined based on the L7 DDoS attack. For example, updating the L7 WAF to filter out malicious traffic being sent by a particular machine for a period of time. As another example, the mitigation policy may be updated to limit the traffic being sent to a particular endpoint for a period of time. As yet another example, the mitigation policy may throttle the traffic of a public cloud native WAF to filter out malicious traffic from being sent to a virtual container. Additional details regarding the determination for the mitigation policy are discussed with respect to the method 700 shown in FIG. 7 as well as the method 1000 shown in FIG. 10.

The policy state is updated at 1112 to reflect DDoS mitigation activation. In some embodiments, one or more validation operations may be. For example, a determination may be made as to whether the local and remote versions of the policy are the same. Differences in policies may be resolved by, for instance, a pull request.

A determination is made at 1114 as to whether the DDoS attack in question is related to the computing services environment configured in a first party cloud provider configuration. According to various embodiments, the determination may be made by using the information gathered as discussed with respect to the operations 1102 through 1108.

Upon determining that a first party configuration is implicated, then network traffic is rerouted at 1116 to the first party L7 WAF. In some embodiments, the L7 WAF may begin to filter out traffic that meets the malicious traffic criteria.

Upon determining that a first party configuration is not implicated, then at 1118 a determination is made as to whether the computing services environment is configured with a public cloud-native WAF configuration. In some embodiments, the public cloud provider may host the cloud-native and L7 WAF for the virtual container.

Upon determining that a cloud-native WAF is available, the cloud-native WAF is activated at 1122. According to various embodiments, activating the cloud-native WAF may involve any of one or more operations. For example, before any traffic is rerouted through the cloud-native WAF to filter out malicious traffic, the cloud-native WAF may first be activated. Additionally, any competing L7 WAF may be disabled.

After the cloud-native WAF is activated, the traffic is rerouted through the cloud-native WAF at 1124. According to various embodiments, the public cloud-native WAF will filter out traffic before it reaches the virtual container. The traffic filtering may be defined based on the attack mitigation policy.

Upon determining instead that a cloud-native WAF is not available, then the internet gateway is instructed at 1120. According to various embodiments, the instruction set may include an indication to wait for L7 WAF approval. For example, the internet gateway 1024 may route traffic to the L7 WAF 1028. When attack mitigation is in place, the internet gateway 1024 may then wait for approval from the L7 WAF 1028 before forwarding traffic to the application 1029. In contrast, when attack mitigation is not in place, the L7 WAF 1028 may operate in a “listen” only mode, where the L7 WAF is receiving traffic, the ingress/load balancers 1026 do not wait for WAF approval before processing and forwarding the traffic.

The instructions are sent to the appropriate WAF controller at 1126. According to various embodiments, the WAF controller may contact the WAF via an appropriate application procedure interface. For example, when contacting the WAF on a public cloud provider, the WAF controller may send the instructions to the WAF via the public cloud provider's API.

FIG. 12 illustrates a method 1200 of application-layer distributed denial of service mitigation policy merge request state updating, performed in accordance with one or more embodiments. The application-layer DDoS policy that is updated by the method 1200 may then be used to control the operation of various components of a computing services environment. For instance, the policy may be used to control one or more web application firewall configurations as shown in FIG. 10. The method 1200 may be performed to implement a policy change such as a policy change described with respect to FIG. 11 or FIG. 13.

In some embodiments, policy may be stored and updated in a version control system. For instance, the method 1200 is described as including “pull requests”, which provide for updating information in a version control system such as GitHub, GitLab, Bitbucket, Azure Repos, and AWS CodeCommit. However, the terms “pull request” and “merge request” may be used exchangeable depending on the type and version of the remote versioning system being used. Examples of remote version control systems include. Moreover, techniques and mechanisms described herein do not require a version control system, and indeed may function in a system configured in a different way.

The mitigation policy is retrieved at 1202. According to various embodiments, the retrieval process may involve communicating with a remote repository. For example, the mitigation policy can be retrieved to a local environment by initiating a pull request from a remote repository.

The policy values are updated at 1204. According to various embodiments, the policy values may be updated. For example, the local version of the policy may reflect information communicating the policy may be outdated. As another example, the local version of the policy may reflect information communicating a unique key.

A determination is made at 1206 as to whether the attack has subsided. The L7 DDoS attack may be classified as subsided for one or more reasons. In some embodiments, the deactivation request may be triggered depending on the volume of traffic. For example, the deactivation request may be triggered whenever the traffic volume for a given set of domains falls below the threshold. As another example, the deactivation request may be triggered whenever a change in rate of traffic for a given set of domains falls below a rate change threshold. Additional details regarding the deactivation of attack mitigation in a WAF are discussed with respect to the method 1300 shown in FIG. 13.

A determination is made at 1208 as to whether to prevent or detect an L7 DDoS attack. In some embodiments, the determination may be made as discussed with respect to the method 1100 shown in FIG. 11.

The policy is updated at 1210 to reflect a prevent mode. For example, a field associated with the WAF mode may be updated to a value associated with the prevent mode.

The policy is then published at 1212, and the state is updated at 1214 to mitigated. Publishing the policy may bring the remote version of the policy in line with the local version of the policy.

Mode and mitigation reset pull requests are generated at 1216. In some embodiments, the mode and mitigation reset pull requests may update the remote state for the purpose of updating the configurations at the cloud providers, as discussed with respect to FIG. 10.

An expiration timer is started at 1218. In some embodiments, the expiration timer may be set to enforce a maximum time for keeping in place the mitigation state as determined by the prevent mode policy.

A determination is made at 1220, as whether or not the expiration timer has expired. Upon determining that the expiration timer has expired, then one or more policy values are updated at 1222 to reflect the expiration, and the merge request is auto committed at 1224 to publish the policy values.

Upon determining the mode is set to detect an L7 DDoS attack from 1208, the mode of the policy is updated to reflect the detection mode at 1226. After updating the mode, the pull request may auto commit move to archive the pull request.

Upon determining the attack has subsided in 1206, the policy is updated at 1228 to reflect detection mode. For example, a mode field may be updated to store a value associated with detection mode.

The policy is published at 1230. According to various embodiments, publishing the policy may involve one or more steps in the remote versioning system. For example, a local branch of the versioning system may be moved to the remote branch to reflect the changes.

The merge request is closed at 1232. According to various embodiments, closing the merge request may be done automatically after merging the local and remote branches. For example, automatically deleting branches after merging using GitHub Actions.

The merge request is archived at 1234. For example, an auto-commit feature may be used to move the pull request to an archive.

FIG. 13 illustrates a method 1300 of application-layer distributed denial of service orchestrator attack mitigation deactivation. According to various embodiments, the attack mitigation deactivation method initially gathers relevant information, based on the computing services environment and the DDoS attack information, to communicate with the appropriate WAF to stop filtering out traffic.

A request to deactivate DDoS mitigation is received at 1302. According to various embodiments, the DDoS mitigation request may be sent by the DDoS Detection System. For example, an alert is sent to the orchestrator by the DDoS Detection System to reflect a DDoS attack has subsided. Additional details regarding the detection of a DDoS attack are discussed with respect to the method 500 shown in FIG. 5.

Computing services environment information is determined at 1304. The determination of the computing services environment information at 1304 may be substantially similar to the determination of such information at 1104.

WAF mitigation policy state information is determined at 1306. According to various embodiments, the orchestrator may identify the mitigation policy that was active during attack mitigation period, for instance by accessing the version control system and/or one or more cloud controllers to gather the type of state the WAF is currently in based on prior policies. As another example, the orchestrator may update any default values based on the WAF state. As yet another example, the orchestrator may communicate with the cloud controllers to reboot the respective WAF.

Network traffic flow information is determined at 1308. According to various embodiments, network traffic flow may include previously determined malicious traffic. The attack information may be gathered by one or more resources. For example, the attack information may be passed in as part of the request to deactivate the DDoS mitigation. As another example, the orchestrator may need to communicate with the DDoS Detection System to gather attack information. Additional details regarding the information collected to identify whether an attack is occurring or has been mitigated are discussed with respect to FIG. 3.

An updated mitigation policy is determined at 1310. According to various embodiments, the mitigation policy is determined based on the L7 DDoS attack information. For example, the L7 WAF may be updated to filter out traffic being sent by a particular machine for a period of time. As another example, the mitigation policy may be updated to stop limiting the traffic being sent to a particular endpoint for a period of time. As yet another example, the mitigation policy may stop throttling the traffic of a public cloud native WAF to filter out traffic from being sent to a virtual container.

The policy state is updated at 1312 to reflect DDoS mitigation deactivation. In some embodiments, validation operations may be performed to verify all versions of the policy are the same. For example, updating the policy and verifying the local and remote versions of the policy are the same. Additional details regarding policy state updates are discussed with respect to the method 1100 shown in FIG. 11.

A determination is made at 1314 as to whether the DDoS attack in question is related to the computing services environment configured in a first party cloud provider configuration. According to various embodiments, the determination may be made by using the information determined as discussed with respect to the operations 1302-1312.

Upon determining that a first party configuration is implicated, network traffic routed away from the first party L7 WAF at 1316. In some embodiments, the traffic may be redirected to travel directly from the L3/L4 routers 1012 to the ingress/load balancers 1014. In this way, the L7 WAF 1018 may be configured to no longer filter the traffic.

Upon determining instead that a first party configuration is not implicated, a determination is made at 1318 as to whether the computing services environment is configured with a public cloud-native WAF configuration. The determination may be made based on the configuration, policy, and state information determined as discussed with respect to the operations 1302-1312.

Upon determining that a cloud-native WAF is being employed, traffic is rerouted away from the cloud-native WAF at 1322. For instance, traffic may be rerouted from the internet gateway 1032 directly to the ingress/load balancers 1036, bypassing the cloud native WAV 1038.

The cloud-native WAF subscription is deactivated at 1324. According to various embodiments, deactivating the cloud-native WAF subscription may involve operations such as transmitting an instruction via an application procedure interface provided by the public cloud provider.

Upon determining instead that a cloud-native WAF has not been employed, the internet gateway is placed back in listen-only mode at 1320. According to various embodiments, the default phase can be considered a “listen” only, where the L7 WAF is receiving traffic, but is not authorized to filter any traffic to the endpoint.

The instructions are sent to the appropriate WAF controller at 1334. According to various embodiments, the WAF controller may contact the WAF and/or other suitable components via an API. For example, when contacting the WAF on a public cloud provider, the WAF controller may send the instructions to the WAF via the public cloud provider's API.

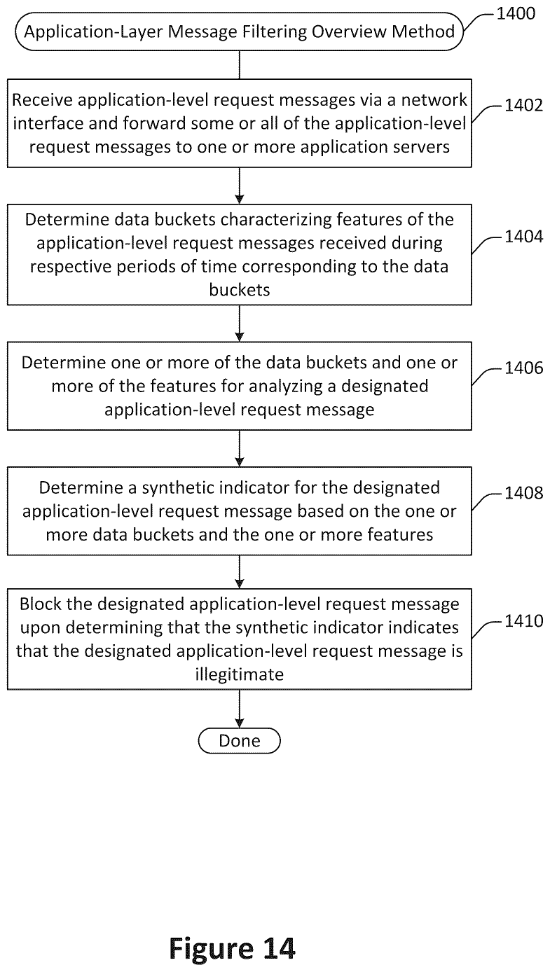

FIG. 14 illustrates an overview method 1400 for filtering application-layer messages at a computing services environment, performed in accordance with one or more embodiments. The method 1400 may be performed at a computing services environment such as the computing services environment 200 shown in FIG. 2.

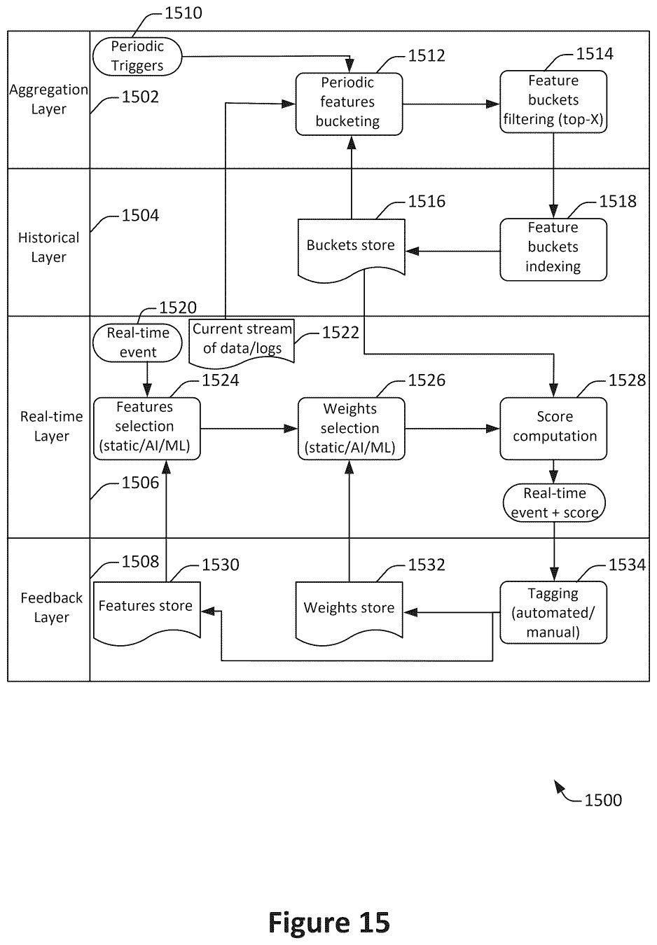

FIG. 14 is described partially in reference to FIG. 15, which illustrates an architecture diagram 1500 showing interactions between various components associated with traffic filtering. The architecture diagram includes an aggregation layer 1502, a historical layer 1504, a real-time layer 1506, and a feedback layer 1508.

In some embodiments, the aggregation layer 1502 is responsible for the periodic aggregation and filtration of features. These processed features are then made available to the historical layer 1504. The aggregation layer 1502 includes operations related to periodic triggers 1510, periodic features bucketing 1512, and feature bucket filtering 1514.

In some embodiments, the historical layer 1504 stores and indexes features to facilitate constant time complexity during query operations. The historical layer 1504 layer can be queried by the aggregation layer 1502, the real-time layer 1506, and the feedback layer 1508. The historical layer 1504 includes operations related to bucket storage 1516 and bucket indexing 1518.

In some embodiments, the real-time layer 1506 computes and outputs the score for specific events, such as the establishment of a new connection or a set of connections. The real-time layer 1506 includes operations related to real-time event detection 1520, stream of data generation 1522, feature selection 1524, weight selection 1526, and score computation 1528.

In some embodiments, the feedback layer 1508 aids the real-time layer 1506 in selecting the most appropriate features, weights, and/or buckets for score computation. The feedback layer 1508 includes operations related to feature storage 1530, weight storage 1532, and tagging 1534.

Returning to FIG. 14, application-level request messages are received at 1402 via a network interface. Some or all of the application-level request messages are forwarded to one or more application servers. According to various embodiments, various types of network-related events may be encompassed by the term application-level request message. Examples of such events may include, but are not limited to: the creation of a new connection, a security alert, and/or the receipt of a message from a source outside of the computing services environment.

According to various embodiments, request messages may be received in the context of providing computing services to various entities via the Internet. For instance, the computing services may include on-demand database services, customer relations management services, sales relations management services, and/or other types of cloud computing services. Additional details regarding the types of computing services that may be provided are discussed in additional detail throughout the application, for instance with respect to FIG. 21, FIG. 22A, and FIG. 22B.

Data buckets characterizing features of the application-level request messages received during respective periods of time corresponding to the buckets are determined at 1404. According to various embodiments, a data bucket may store values corresponding with features of traffic data. These traffic features may include characteristics of network traffic such as the IP address of the traffic source, the HTTP method, the HTTP user agent, the HTTP response code, the TLS version, the domain to which the traffic is directed, the entity associated with the traffic (e.g., an entity to which the computing services environment provides computing services), and/or any other suitable traffic feature.

For example, as shown in FIG. 15, one or more periodic triggers 1510 may trigger feature bucketing 1512, after which the feature buckets may be filtered at 1514, for instance to reduce storage size and/or improve computational efficiency when computing scores. Feature buckets may be indexed at 1518 for rapid search and retrieval, and stored at 1516 for access in score computation. Feature bucketing may be conducted based at least in part on a stream of data and/or logs received from the real-time layer 1506. For instance, the stream of data and/or logs may include information on recently received network traffic.

In some embodiments, a data bucket may include data values for only a single feature for a time interval. Alternatively, a data bucket may include data aggregated across more than one feature for a given time interval.

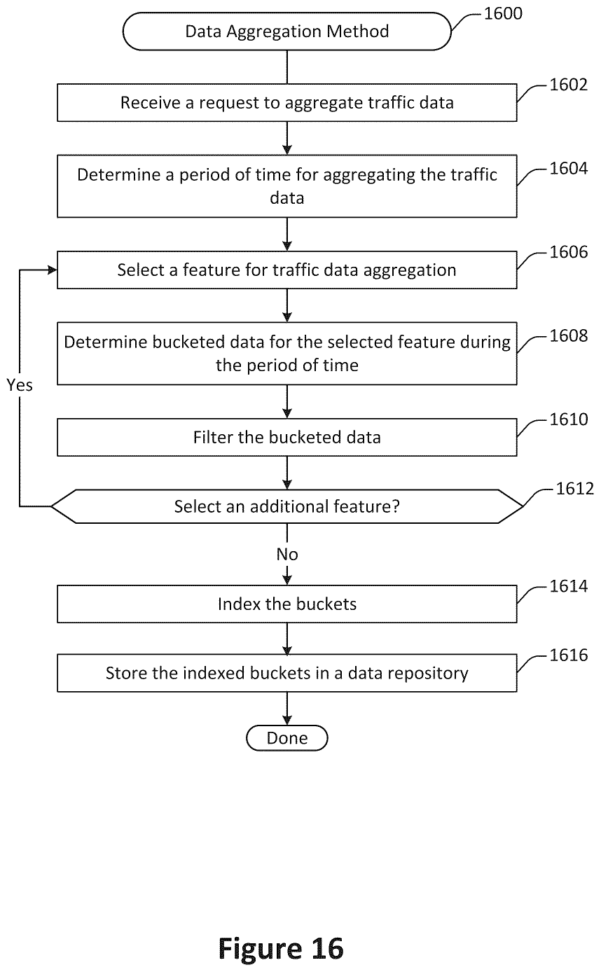

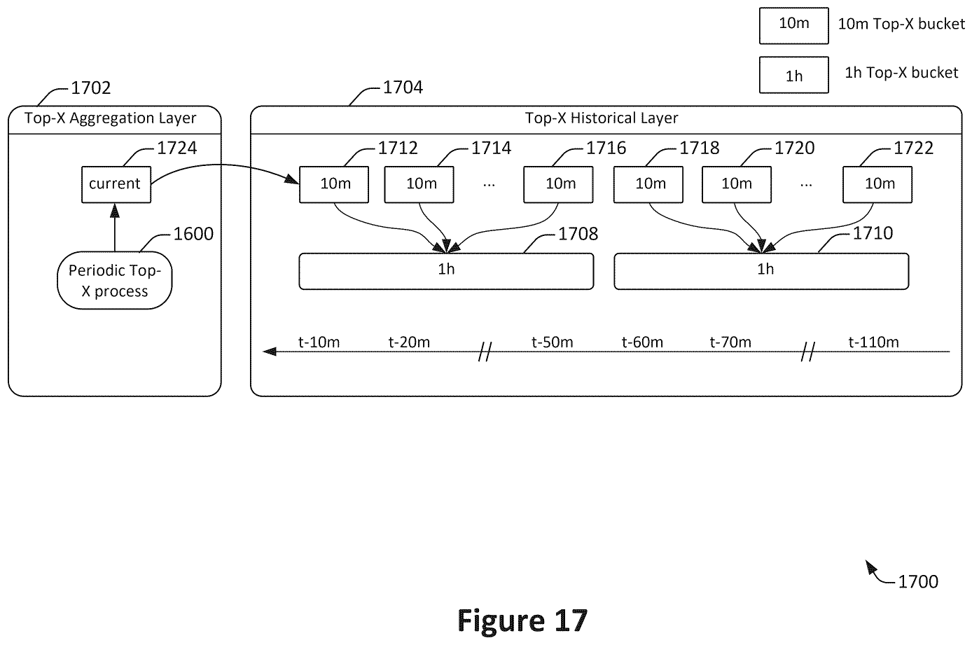

According to various embodiments, determining the data buckets may involve operations such as collecting feature data values for some or all of the application-level request messages, aggregating the feature data across a temporal interval corresponding with a bucket, and/or filtering, coarsening, or otherwise processing the feature data values. Additional details regarding such operations are discussed with respect to the method 1600 shown in FIG. 16 and the diagram 1700 shown in FIG. 17.

At 1406, upon receiving a designated application-level request message, one or more of the data buckets and one or more of the features are determined. The one or more data buckets may serve as a comparison set for determining whether the designated application-level request message is legitimate or malicious, while the one or more features may serve as a basis for comparison. Additionally, one or more weights for weighting the features and/or buckets may be determined.

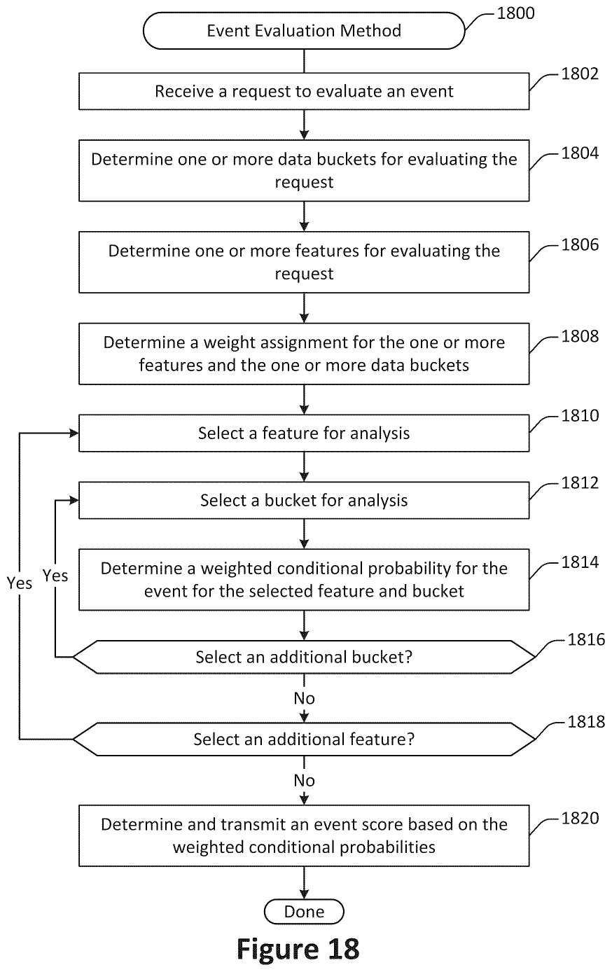

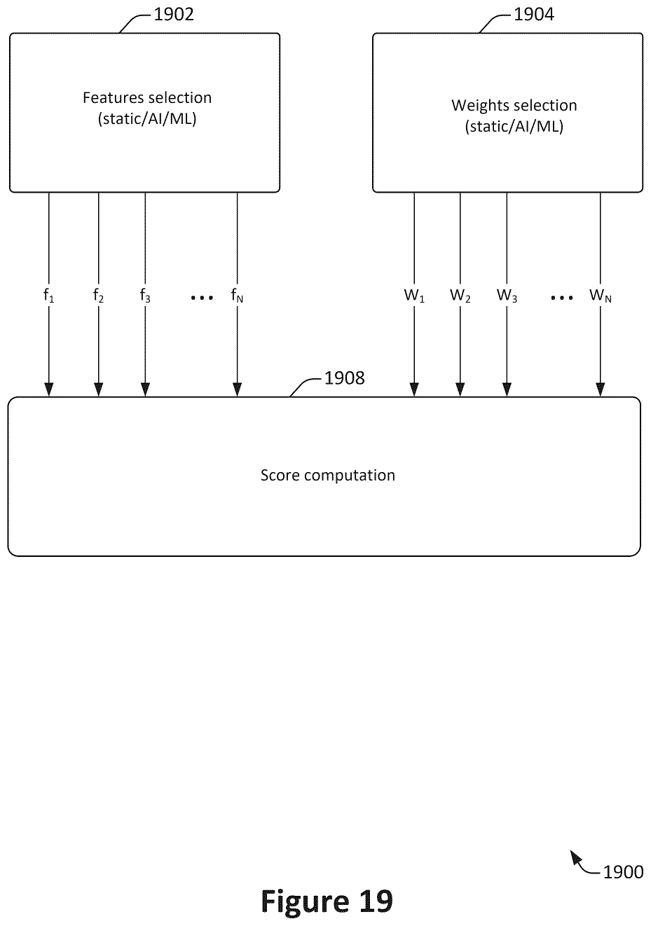

A synthetic indicator for the designated application-level request message is determined at 1408. In some embodiments, the synthetic indicator may indicate whether the application-level request message is likely to be legitimate or malicious based on the extent to which characteristics of the designated application-level request message corresponding with the features are represented in the feature buckets. For example, if the designated application-level request message is from an IP address from which many legitimate messages have been received in the past, is sent with a common TLS version, and is sent using a common HTTP method, the designated application-level request message may be identified as legitimate since the likelihood score reflected in the synthetic indicator would reflect that the designated application-level request message seems normal relative to the traffic reflected in the buckets selected for comparison. If instead the designated application-level request message exhibits characteristics that are unusual relative to the traffic reflected in the buckets selected for comparison, then the designated application-level request message may be identified as malicious. Additional details regarding the determination of the data buckets, the features, and the synthetic indicator are discussed with respect to the method 1800 shown in FIG. 18 and the diagram 1900 shown in FIG. 19.

Upon determining that the synthetic indicator indicates that the designated application-level request message is illegitimate (e.g., malicious), the designated application-level request message is blocked at 1410. In some embodiments, blocking the designated application-level request message may involve not forwarding it from the network ingress to an application server. Additional details regarding the filtering of application-level network traffic are discussed throughout the application, for instance with respect to FIG. 1 through FIG. 13.

For example, a real-time event 1520 may trigger the selection of features 1524, the determination of weights at 1526, and/or the determination of buckets retrieved from the bucket store at 1516. These elements may be combined to determine a score for the event at 1528.

According to various embodiments, information determined based on the real-time event may be provided to a feedback layer 1508, which may be used to refine the selection of features, the determination of weights, and/or the determination of buckets. For instance, the real-time event may be manually or automatically tagged as legitimate or malicious at 1534. Such information may then be stored in conjunction with the weights at 1532 and features at 1530 and used to guide the selection of weights, features, and buckets when analyzing future events.

FIG. 16 illustrates a method 1600 for aggregating traffic data, performed in accordance with one or more embodiments. The method 1600 may be performed at a computing services environment such as the computing services environment 200 shown in FIG. 2.

FIG. 16 is described partially in reference to FIG. 17, which illustrates a diagram 1700 showing a division of traffic aggregation data determined in accordance with one or more embodiments. FIG. 17 includes an aggregation layer 1702 and a historical layer 1704. The aggregation layer 1702 includes the periodic aggregation process 1600, which is used to determine filtered and bucketed data for storing in the historical layer 1704. The historical layer 1704 includes time periods of data 1708 and 1710. Each time period of data may include one or more buckets of data, such as the buckets 1712 and 1714 through 1716, and the buckets 1718 and 1720 through 1722.

A request to aggregate traffic data is received at 1602. In some embodiments, the request may be generated at regular intervals. For instance, traffic data may be aggregated at an interval such as once per minute, once per ten minutes, once per hour, or at any other suitable cadence.

In some embodiments, the method 1600 may be run to produce buckets at different levels of aggregation. For example, buckets may be produced at intervals of every 10 minutes to ensure that traffic patterns may be compared against recent data. Then, buckets may be aggregated further on a different cadence (e.g., once per hour) to provide for more efficient storage and comparison to historical data.

In some embodiments, the method 1600 may be used to generate buckets at standardized frequencies, for instance to ensure that the data is consistently segmented. However, the flexibility of the system allows for the generation of buckets at other frequencies, thereby accommodating diverse data processing requirements without compromising the generality of the approach.

In some embodiments, the method 1600 may be used to reflect the characteristics of all traffic received in a designated time interval within the feature values stored in a bucket. Alternatively, or additionally, a statistical approach may be adopted for one or more buckets and/or feature values. For instance, traffic may sample at random to reduce the computational overhead associated with traffic data aggregation.

A time period for aggregating the traffic data is determined at 1604. In some embodiments, the traffic data may be aggregated in an interval spanning from the time that the request is generated extending backward in time to the penultimate time interval during which traffic data was collected. In this way, all or substantially all traffic data may be reflected in a respective data aggregation time interval.

A feature for traffic data aggregation is selected at 1606. According to various embodiments, one or more of a variety of types of features may be used to characterize application-level messages received by the computing services environment. Examples of features for which to aggregate traffic data may include, but are not limited to: the source IP address of a message, the organization ID corresponding to the domain to which the message is directed, the HTTP method, the HTTP user agent, the HTTP response code, and the transport layer security (TLS) version. The features for which to aggregate traffic data may be determined based on configuration information specified by a network administrator or other source

Bucketed data for the selected feature during the period of time is determined at 1608. In some embodiments, the bucketed data may include information about the traffic received during the time interval characterizing the selected feature. For example, for a source IP address feature, the bucketed data may include a list of all source IP addresses for messages received during the time interval. As another example, for an HPTTP user agent feature, the bucketed data may include a list of all user agents associated with messages received during the time interval.

In some implementations, bucketed data may include information for combinations of features. For example, a feature may identify a list of combinations of source IP addresses and user agents. As another example, a feature may identify a list of combinations of HTTP method and HTTP user agent.

In some embodiments, bucketed data may include information counting the number of times a feature value has occurred. For example, a feature corresponding to the HTTP response code may include a count associated with each HTTP response code associated with a message received during the interval. In this way, the bucketed data may reflect not only the occurrence of a feature value but also the frequency at which the feature value occurs.

The bucketed data is filtered at 1610. In some embodiments, filtering may be employed to mitigate the cardinality of the data, which is particularly beneficial for high-traffic domains. By selectively preserving only the more common values, the system can significantly reduce the data volume to be stored.

According to various embodiments, the aggressiveness with which filtering is performed may depend on any of various characteristics. For example, domains with high traffic may be filtered to decrease the cardinality by potentially several orders of magnitude. As another example, filtering may be more aggressive with features that have a high or unbounded domain. For instance, the IPv4 address space encompasses 2³² possible addresses. Storing up to 2³² IP addresses for each domain every ten minutes may be impractical. By reducing the data cardinality, the system not only decreases space complexity but can also enhance query performance.

In some embodiments, filtering the bucketed data may involve one or more coarsening operations. For example, IP addresses may first be coarsened to the first 9 digits. Once coarsened, each unique value may then be associated with a count of the number of times that unique value has occurred in the traffic data.

In some implementations, filtering the bucketed data may involve truncating the bucketed data to the most common values. For example, IP addresses may be truncated to the top 1,000,000 unique values. Such truncation may occur in conjunction with (e.g., after) coarsening. As another example, user agent values that represent a proportion of traffic below a designated threshold may be ignored.

A determination is made at 1612 as to whether to select an additional feature. According to various embodiments, features may be selected for traffic data aggregation in any suitable order, in sequence or in parallel.

The buckets are indexed at 1614. According to various embodiments, indexing may support improved query-time complexity. Any of various indexing techniques may be employed. For instance, hash-based methods such as Bloom filters may be used.

The indexed buckets are stored in a data repository at 1616. The data repository may store information associated with the historical layer 1704. In some embodiments, storing the bucketed and filtered data in the data repository may involve associating the bucketed and filtered data with a time period. For example, the most recently aggregated data 1724 may be associated with the most recent period of time 1708 at 1712.

FIG. 17 illustrates a diagram 1700 providing an example of a possible division of data into time periods and buckets. In practice, buckets may be of any suitable length of time, and time periods may include any suitable number of buckets. Moreover, FIG. 17 illustrates only a limited number of buckets and time periods, although in practice the historical layer 1704 may store a potentially large number of buckets and time periods.

According to various embodiments, buckets may be generated in a manner that is specific to a subset of the traffic received. For example, a bucket may be specific to one or a combination of characteristics such as domain, sub-domain, application server, ingress, and entity. In this way, traffic for one portion of a shared infrastructure environment, such as a particular domain associated with a particular entity accessing computing services via the computing services environment, may be analyzed separately from other traffic, such as traffic associated with a different entity.

FIG. 18 illustrates a method 1800 for evaluating an event, performed in accordance with one or more embodiments. The method 1800 may be performed at a computing services environment such as the computing services environment 200 shown in FIG. 2.

FIG. 18 is described partially in reference to FIG. 19, which illustrates a diagram 1900 showing various inputs to score computation. FIG. 19 includes a feature selection component 1902, a weight selection component 1904, and score computation component 1906.

A request to evaluate an event is received at 1802. In some implementations, the request may be received at an interface configured to receive requests to be processed by the real-time layer 1506 shown in FIG. 5.

According to various embodiments, any of a variety of types of events may be analyzed. For example, an event may be an attempt to establish a connection, an attempt to establish a group of connections, a message received after a connection has been established, and/or any other application-level network traffic.

In some embodiments, the request may be generated as part of a traffic analysis process. For example, the request may be generated by a web server 212A or a web server 222A as part of an edge network 210 or an ingress network 220 shown in FIG. 2. As another example, the request may be generated by an L7 WAF such as the WAFs 1018, 1028, or 1038 shown in FIG. 10.

In some embodiments, a request to evaluate an event may be generated for any L7 message received by the computing services environment 200. For example, a request may be generated for each event received during a time when attack mitigation is in place. As another example, a request may be generated periodically (e.g., once per second) and may identify multiple events to be separately analyzed by the API. As yet another example, a request may be generated for each event received by a WAF, regardless of whether attack mitigation is being conducted.

In some implementations, a request to evaluate an event may be generated for specific L7 events. For instance, the event may be evaluated only upon the WAF determining that the event may be malicious. In such a configuration, the evaluation of the event may serve as a second-pass filter used to distinguish true positive from false positive events as initially categorized by the WAF, for instance by a less accurate analysis applied at the WAF.

One or more data buckets for evaluating the request are determined at 1804. In some embodiments, the one or more data buckets may be selected from the historical layer. The buckets may be selected so as to provide a suitable basis of comparison for determining a score indicating whether the event identified at 1802 is likely to be legitimate traffic.

According to various embodiments, various techniques, mechanisms, and/or criteria may be used to select the one or more data buckets. For instance, one or more buckets may be selected from the recent past. In this way, the score may reflect the extent to which the event is consistent with recently received traffic.

In some embodiments, one or more buckets may be selected from previous time periods corresponding to a time associated with the event. For instance, one or more buckets may be selected from the same day of the week, time of day, calendar date, holiday, or other such previous period of time. In this way, the likelihood score may reflect traffic seasonality, such as changes in the types of traffic received at various times.

In some implementations, one or more buckets may be selected from previous time intervals that match one or more defining characteristics associated with the time interval in which the event indicated at 1802 is identified. For instance, buckets may be matched based on characteristics such as traffic volume, traffic type, database load, compute load, and/or any other suitable criteria.

In some embodiments, one or more buckets may be selected based on a manually specified criterion. For instance, a network administrator may provide configuration data indicating that at least the previous two hours of traffic data is to be included when determining the likelihood score.

In some implementations, one or more buckets may be selected based on a dynamic determination. For instance, a deep learning neural network may be trained to select buckets. Such a neural network may be trained so as to select buckets that are likely to generate a more accurate synthetic indicator and corresponding likelihood score. For instance, the neural network may be trained based on data retrieved from the feedback layer.

One or more features for evaluating the event are determined at 1806. According to various embodiments, any of the features discussed with respect to FIG. 18 and FIG. 19 may be selected. In some configurations, one or more features may be manually specified. Alternatively, or additionally, one or more features may be determined dynamically, for instance by a deep learning model configured as discussed with respect to the operation 1804.

A weight assignment for the one or more features and the one or more data buckets is determined at 1808. In some implementations, the weight assignments may indicate the relative importance of features and/or buckets in generating the final score. For instance, weights may sum to 1 across features and/or buckets.

In some embodiments, features and buckets may be weighted separately. For instance, one set of weights may weight the buckets when determining the feature-level scores, while another set of weights may weight the features when determining the event-level score.

In some embodiments, a weight for a feature may be implemented as a vector. For instance, the vector may include different values for different buckets within the same feature. In this way, the score may reflect differences in how different combinations of features and buckets are to be treated. For example, a weight vector for a feature corresponding to IP addresses may weight recent buckets more heavily than buckets in the distant past, since the system may be more likely to receive traffic from a source from which it has recently received traffic than a source from which traffic was received in previous days, weeks, or months. As another example, a weight vector for a feature corresponding to HTTP user agent may weight buckets corresponding to the same time of day on previous days more heavily than buckets for previous hours in the same day, for instance if traffic analysis reveals strong seasonal patterns to HTTP user agent values.

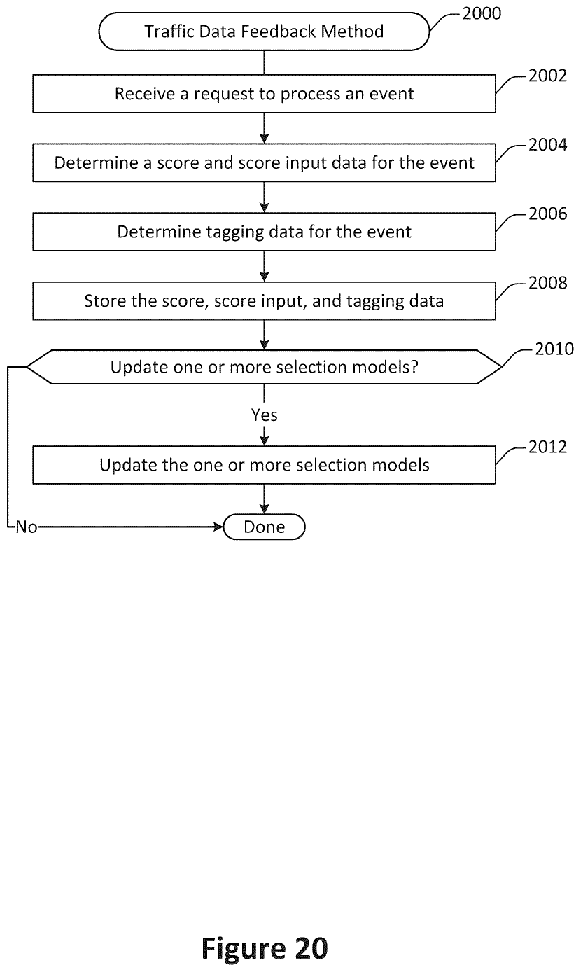

In some embodiments, one or more weights may be manually specified. Alternatively, or additionally, one or more weights may be determined dynamically, for instance by a deep learning model configured as discussed with respect to the operation 1804. Additional details regarding the determination of buckets, weights, and features are discussed with respect to the method 2000 shown in FIG. 20.

A feature is selected for analysis at 1810. A bucket is selected for analysis at 1812. According to various embodiments, features and buckets determined as discussed with respect to the operations 1804 and 1806 may be selected for analysis in any suitable order, in sequence or in parallel.

A weighted conditional probability is determined for the event for the selected feature and bucket at 1814. According to various embodiments, various techniques, mechanisms, and/or formulae may be used for determining the conditional probability. For instance, in some configurations equation (1) may be used. In equation (1), sᵢ represents the score for feature i, M represents the number of buckets determined at 1804, p represents the indexed bucket, i represents the feature index, W_{P} represents a vector of weights that controls the relative importance of different buckets in computing the score, fᵢ represents the indexed feature, and P, represents a function providing the conditional probability of the feature fᵢ occurring in the bucket Bₚ. The conditional probability is conditioned on a vector φ. Information included in the vector may include, but is not limited to: the domain with which the event is associated, the web application firewall at which the event is identified, and the functional domain associated with the event.

$${s}_{i} = {\sum }_{p = 1}^{M} {W}_{p} ( 1 - {P}_{p} ( {f}_{i} \vert Φ ) ) \qquad ( 1 )$$

A determination is made at 1816 as to whether to select an additional bucket for analysis. Upon determining to select an additional bucket for analysis, the additional bucket is selected at 1812. Upon determining instead not to select an additional bucket for analysis, a determination is made at 1818 as to whether to select an additional features for analysis. Upon determining to select an additional feature for analysis, the additional feature is selected at 1810. According to various embodiments, additional features and buckets may continue to be selected until all features and buckets determined at 1806 and 1804 have been evaluated.

An event score is determined and transmitted at 1820 based on the weighted conditional probabilities. According to various embodiments, any of a variety of formulae and/or processes may be used to compute the event score. For example, the event score may be computed based on the following equation. In this equation, s represents the total score, N represents the number of features determined at 1806, wᵢ represents the weight assigned to the indexed feature, and sᵢ represents the score determined for the indexed feature (e.g., via equation (1)):

$$s = {\sum }_{i = 1}^{N} {w}_{i} {s}_{i} \qquad ( 2 )$$

According to various embodiments, an event score computed as discussed with respect to the operation 1820 may be transmitted to one or more of various recipients. For example, the event score may be transmitted to the source of the request for the event score, such as a WAF. As another example, the event score may be transmitted to a storage device, for instance for use in a feedback layer.

In some embodiments, transmitting the event score may involve applying a threshold. In the example equations discussed above, the event score (also referred to herein as a synthetic indicator) is constrained to fall between 0 and 1, with higher scores indicating that the event represented by the score is unusual in comparison to the bucketed comparison data along the feature dimensions. A threshold may be used so that the event evaluation method returns a yes/no indication as to whether to block the event.

According to various embodiments, the threshold may depend in significant part on factors such as the nature and number of the features, the amount of data reflected in the buckets, the number of buckets, the weights, and the like. For example, when features associated with more granular values such as a large set of IP address ranges contribute significantly to the score, a higher threshold may need to be used, since any particular IP address may be somewhat unusual. As another example, when features associated with less granular values such as HTTP user agent contribute significantly to the score, a lower threshold may need to be used, since the relatively small number of user agents may tend to decrease the scores overall.

In some embodiments, the threshold may be determined based on user input. Alternatively, a dynamic threshold may be used. For example, the threshold may be determined by statistical analysis to identify outliers. As another example, the threshold may be determined by a deep learning neural network model that determines the buckets, features, and/or weights.

FIG. 20 illustrates a method 2000 for determining and incorporating traffic data feedback, performed in accordance with one or more embodiments. The method 2000 may be performed at a computing services environment such as the computing services environment 200 shown in FIG. 2.

According to various embodiments, the method 200 may be performed to refine the scoring mechanism. For instance, the score may be tagged with additional security data, which may be used to refine the process for selecting the buckets, features, and/or weights for score computation. The feedback loop provides for adaptation and improvement over time, leading to more accurate and reliable outcomes.

A request to process an event is received at 2002. In some embodiments, the request may be generated for each event for which a score is generated. Alternatively, or additionally, the request may be generated periodically, for instance for batches of events.

A score and score input data for the event are determined at 2004. In some embodiments, the score input data may include the buckets, features, and/or weights used to determine the score. the score and score input data may be determined as discussed with respect to the method 1800 shown in FIG. 18.

Tagging data for the event is determined at 2006. In some embodiments, the tagging data may indicate whether the event was ultimately determined to be malicious or benign. For instance, the score may be determined prospectively to aid in determining whether or not to block the event before a request is forwarded to an application server. However, subsequent analysis may reveal whether the event was actually malicious or benign.

In some embodiments, some or all of the tagging information may be determined manually. For instance, a systems administrator may review events identified as malicious and tag such events as malicious or benign.

In some embodiments, some or all of the tagging information may be determined automatically. For example, the application server may provide information indicating that a request that was initially identified as benign was in fact actually malicious. As another example, subsequently received traffic data, such as a successful connection request from the same source as an event initially identified as malicious, may indicate that the original event was actually not malicious.

The score, score input, and tagging data are stored at 2008. In some embodiments, the score, score input, and tagging data may be stored in the a data repository accessible to the feedback layer that may be used for refining the selection process.

A determination is made at 2010 as to whether to update one or more selection models. In some embodiments, the determination may involve evaluating whether a sufficient amount of new training data is available for retraining a model. For example, a selection model may be retrained periodically (e.g., once per week) or when the amount of additional training data not yet incorporated into the selection model exceeds a designated threshold.

The one or more selection models are updated at 2012. In some embodiments, a selection model may be implemented as a deep learning neural network model which receives as input parameters such as characteristics of the event and the event context. For instance, such characteristics may include one or more feature values associated with the event, timing information for the event, source and/or recipient information for the event, traffic characteristics for traffic received during the same time period as the event, and/or any other suitable information. The deep learning neural network model may then produce output values such as: (1) bucket identifiers uniquely identifying comparison buckets for computing the score for the event, (2) feature identifiers uniquely identifying features used for computing the score for the event, and/or (3) weight values identifying the relative importance of buckets and/or features for computing the score. The deep learning neural network model may be trained based on outcome data indicating the success of the produced output values in determining a score that accurately predicts the tagging data.

### Example Computation

Consider the following example, in which an event having the following characteristics is received:
Domain d=Acme.domain.com
Functional domain δ=edge
Instance <φ=provider-unit-region
   For simplicity, suppose that (N=2) features include the user agent (f₁) and the source IP address (f₂). Again for simplicity, consider a single bucket for each feature having a width of 10 minutes, starting 10 minutes in the past. Finally, again for simplicity, assume that the feature weights are set to 1/2. An example bucket for the user agent is provided below:

| | | | Cumulative | Likelihood |
|---|---|---|---|---|
| Domain | HTTP User Agent | Count | Count | by Domain |
| Acme.domain.com | User Agent 1 | 1 | 848 | 0.001179 |
| Acme.domain.com | User Agent 2 | 5 | 848 | 0.005896 |
| Acme.domain.com | User Agent 3 | 186 | 848 | 0.219334 |
| Acme.domain.com | User Agent 4 | 656 | 848 | 0.773585 |

An example bucket for the source IP address is provided below:

| | | | Cumu- | Likelihood |
|---|---|---|---|---|
| | | | lative | by |
| Domain | IP Address | Count | Count | Domain |
| Acme.domain.com | 123.456.78.90 | 1 | 789 | 0.001267 |
| Acme.domain.com | 123.456.78.189 | 1 | 789 | 0.001267 |
| Acme.domain.com | 123.456.198.180 | 5 | 789 | 0.006337 |
| Acme.domain.com | 123.456.96.170 | 5 | 789 | 0.006337 |
| Acme.domain.com | 123.456.42.202 | 5 | 789 | 0.006337 |
| Acme.domain.com | 123.456.134.232 | 6 | 789 | 0.007604 |
| Acme.domain.com | 123.456.198.201 | 8 | 789 | 0.010139 |
| Acme.domain.com | 123.456.239.8 | 128 | 789 | 0.162230 |
| Acme.domain.com | 123.456.238.117 | 292 | 789 | 0.370088 |
| Acme.domain.com | 123.456.96.164 | 338 | 789 | 0.428390 |

In the previous two tables, the fifth column represents the computed probabilities (i.e., the P's in equation (1)).

Next consider an event that is an HTTP request with User Agent 4 and is received from IP Address 123.225.96.164. In this example, the overall score is computed based on the following equation applying equation (1) and equation (2):

$$s = \frac{1}{2} ( 1 - 0.774 ) + \frac{1}{2} ( 1 - 0.428 ) = \text{.399} \qquad ( 3 )$$

Now consider instead an event that is an HTTP request with User Agent 5 and is received from IP Address 1.1.1.1. In this example, the overall score is computed based on the following equation applying equation (1) and equation (2):

$$s = \frac{1}{2} ( 1 - 0. ) + \frac{1}{2} ( 1 - 0. ) = 1. \qquad ( 4 )$$

The second score indicates that the pattern has never been seen before and hence might suggest a suspicious request, particularly when compared to the first score of approximately 0.4.

### Computing Services Environment Architecture and Operation

FIG. 21 shows a block diagram of an example of an environment 2110 that includes an on-demand database service configured in accordance with some implementations. Environment 2110 may include user systems 2112, network 2114, database system 2116, processor system 2117, application platform 2118, network interface 2120, tenant data storage 2122, tenant data 2123, system data storage 2124, system data 2125, program code 2126, process space 2128, User Interface (UI) 2130, Application Program Interface (API) 2132, PL/SOQL 2134, save routines 2136, application setup mechanism 2138, application servers 2150-1 through 2150-N, system process space 2152, tenant process spaces 2154, tenant management process space 2160, tenant storage space 2162, user storage 2164, and application metadata 2166. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 2116, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 2118 may be a framework that allows the creation, management, and execution of applications in system 2116. Such applications may be developed by the database service provider or by users or third-party application developers accessing the service. Application platform 2118 includes an application setup mechanism 2138 that supports application developers' creation and management of applications, which may be saved as metadata into tenant data storage 2122 by save routines 2136 for execution by subscribers as one or more tenant process spaces 2154 managed by tenant management process 2160 for example. Invocations to such applications may be coded using PL/SOQL 2134 that provides a programming language style interface extension to API 2132. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 2166 for a subscriber making such an invocation. Such system processes may also manage execution of application metadata 2166 as an application in a virtual machine.

In some implementations, each application server 2150 may handle requests for any user associated with any organization. A load balancing function (e.g., an F5 Big-IP load balancer) may distribute requests to the application servers 2150 based on an algorithm such as least-connections, round robin, observed response time, etc. Each application server 2150 may be configured to communicate with tenant data storage 2122 and the tenant data 2123 therein, and system data storage 2124 and the system data 2125 therein to serve requests of user systems 2112. The tenant data 2123 may be divided into individual tenant storage spaces 2162, which can be either a physical arrangement and/or a logical arrangement of data. Within each tenant storage space 2162, user storage 2164 and application metadata 2166 may be similarly allocated for each user. For example, a copy of a user's most recently used (MRU) items might be stored to user storage 2164. Similarly, a copy of MRU items for an entire tenant organization may be stored to tenant storage space 2162. A UI 2130 provides a user interface and an API 2132 provides an application programming interface to system 2116 resident processes to users and/or developers at user systems 2112.

System 2116 may implement a web-based attack detection and mitigation system. For example, in some implementations, system 2116 may include application servers configured to implement and execute software applications for detecting and mitigating distributed denial of service attacks. The application servers may be configured to provide related data, code, forms, web pages and other information to and from user systems 2112. Additionally, the application servers may be configured to store information to, and retrieve information from a database system. Such information may include related data, objects, and/or Webpage content. With a multi-tenant system, data for multiple tenants may be stored in the same physical database object in tenant data storage 2122, however, tenant data may be arranged in the storage medium(s) of tenant data storage 2122 so that data of one tenant is kept logically separate from that of other tenants. In such a scheme, one tenant may not access another tenant's data, unless such data is expressly shared.

Several elements in the system shown in FIG. 21 include conventional, well-known elements that are explained only briefly here. For example, user system 2112 may include processor system 2112A, memory system 2112B, input system 2112C, and output system 2112D. A user system 2112 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 2112 to access, process and view information, pages and applications available from system 2116 over network 2114. Network 2114 may be any network or combination of networks of devices that communicate with one another, such as any one or any combination of a LAN (local area network), WAN (wide area network), wireless network, or other appropriate configuration.

The users of user systems 2112 may differ in their respective capacities, and the capacity of a particular user system 2112 to access information may be determined at least in part by “permissions” of the particular user system 2112. As discussed herein, permissions generally govern access to computing resources such as data objects, components, and other entities of a computing system, such as a social networking system, and/or a CRM database system. “Permission sets” generally refer to groups of permissions that may be assigned to users of such a computing environment. For instance, the assignments of users and permission sets may be stored in one or more databases of System 2116. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 2116 may provide on-demand database service to user systems 2112 using an MTS arrangement. By way of example, one tenant organization may be a company that employs a sales force where each salesperson uses system 2116 to manage their sales process. Thus, a user in such an organization may maintain contact data, leads data, customer follow-up data, performance data, goals and progress data, etc., all applicable to that user's personal sales process (e.g., in tenant data storage 2122). In this arrangement, a user may manage his or her sales efforts and cycles from a variety of devices, since relevant data and applications to interact with (e.g., access, view, modify, report, transmit, calculate, etc.) such data may be maintained and accessed by any user system 2112 having network access.

When implemented in an MTS arrangement, system 2116 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 2116 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 2116 may also maintain system-level data usable by multiple tenants or other data. Such system-level data may include industry reports, news, postings, and the like that are sharable between tenant organizations.

In some implementations, user systems 2112 may be client systems communicating with application servers 2150 to request and update system-level and tenant-level data from system 2116. Byway of example, user systems 2112 may send one or more queries requesting data of a database maintained in tenant data storage 2122 and/or system data storage 2124. An application server 2150 of system 2116 may automatically generate one or more SQL statements (e.g., one or more SQL queries) that are designed to access the requested data. System data storage 2124 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

FIG. 22A shows a system diagram of an example of architectural components of an on-demand database service environment 2200, configured in accordance with some implementations. A client machine located in the cloud 2204 may communicate with the on-demand database service environment via one or more edge routers 2208 and 2212. A client machine may include any of the examples of user systems 2112 described above. The edge routers 2208 and 2212 may communicate with one or more core switches 2220 and 2224 via firewall 2216. The core switches may communicate with a load balancer 2228, which may distribute server load over different pods, such as the pods 2240 and 2244 by communication via pod switches 2232 and 2236. The pods 2240 and 2244, which may each include one or more servers and/or other computing resources, may perform data processing and other operations used to provide on-demand services. Components of the environment may communicate with a database storage 2256 via a database firewall 2248 and a database switch 2252.

Accessing an on-demand database service environment may involve communications transmitted among a variety of different components. The environment 2200 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 22A and 22B.

The cloud 2204 refers to any suitable data network or combination of data networks, which may include the Internet. Client machines located in the cloud 2204 may communicate with the on-demand database service environment 2200 to access services provided by the on-demand database service environment 2200. By way of example, client machines may access the on-demand database service environment 2200 to retrieve, store, edit, and/or process distributed denial of service attack and mitigation information.

In some implementations, the edge routers 2208 and 2212 route packets between the cloud 2204 and other components of the on-demand database service environment 2200. The edge routers 2208 and 2212 may employ the Border Gateway Protocol (BGP). The edge routers 2208 and 2212 may maintain a table of IP networks or ‘prefixes’, which designate network reachability among autonomous systems on the internet.

In one or more implementations, the firewall 2216 may protect the inner components of the environment 2200 from internet traffic. The firewall 2216 may block, permit, or deny access to the inner components of the on-demand database service environment 2200 based upon a set of rules and/or other criteria. The firewall 2216 may act as one or more of a packet filter, an application gateway, a stateful filter, a proxy server, or any other type of firewall.

In some implementations, the core switches 2220 and 2224 may be high-capacity switches that transfer packets within the environment 2200. The core switches 2220 and 2224 may be configured as network bridges that quickly route data between different components within the on-demand database service environment. The use of two or more core switches 2220 and 2224 may provide redundancy and/or reduced latency.

In some implementations, communication between the pods 2240 and 2244 may be conducted via the pod switches 2232 and 2236. The pod switches 2232 and 2236 may facilitate communication between the pods 2240 and 2244 and client machines, for example via core switches 2220 and 2224. Also or alternatively, the pod switches 2232 and 2236 may facilitate communication between the pods 2240 and 2244 and the database storage 2256. The load balancer 2228 may distribute workload between the pods, which may assist in improving the use of resources, increasing throughput, reducing response times, and/or reducing overhead. The load balancer 2228 may include multilayer switches to analyze and forward traffic.

In some implementations, access to the database storage 2256 may be guarded by a database firewall 2248, which may act as a computer application firewall operating at the database application layer of a protocol stack. The database firewall 2248 may protect the database storage 2256 from application attacks such as structure query language (SQL) injection, database rootkits, and unauthorized information disclosure. The database firewall 2248 may include a host using one or more forms of reverse proxy services to proxy traffic before passing it to a gateway router and/or may inspect the contents of database traffic and block certain content or database requests. The database firewall 2248 may work on the SQL application level atop the TCP/IP stack, managing applications' connection to the database or SQL management interfaces as well as intercepting and enforcing packets traveling to or from a database network or application interface.

In some implementations, the database storage 2256 may be an on-demand database system shared by many different organizations. The on-demand database service may employ a single-tenant approach, a multi-tenant approach, a virtualized approach, or any other type of database approach. Communication with the database storage 2256 may be conducted via the database switch 2252. The database storage 2256 may include various software components for handling database queries. Accordingly, the database switch 2252 may direct database queries transmitted by other components of the environment (e.g., the pods 2240 and 2244) to the correct components within the database storage 2256.

FIG. 22B shows a system diagram further illustrating an example of architectural components of an on-demand database service environment, in accordance with some implementations. The pod 2244 may be used to render services to user(s) of the on-demand database service environment 2200. The pod 2244 may include one or more content batch servers 2264, content search servers 2268, query servers 2282, file servers 2286, access control system (ACS) servers 2280, batch servers 2284, and app servers 2288. Also, the pod 2244 may include database instances 2290, quick file systems (QFS) 2292, and indexers 2294. Some or all communication between the servers in the pod 2244 may be transmitted via the switch 2236.

In some implementations, the app servers 2288 may include a framework dedicated to the execution of procedures (e.g., programs, routines, scripts) for supporting the construction of applications provided by the on-demand database service environment 2200 via the pod 2244. One or more instances of the app server 2288 may be configured to execute all or a portion of the operations of the services described herein.

In some implementations, as discussed above, the pod 2244 may include one or more database instances 2290. A database instance 2290 may be configured as an MTS in which different organizations share access to the same database, using the techniques described above. Database information may be transmitted to the indexer 2294, which may provide an index of information available in the database 2290 to file servers 2286. The QFS 2292 or other suitable filesystem may serve as a rapid-access file system for storing and accessing information available within the pod 2244. The QFS 2292 may support volume management capabilities, allowing many disks to be grouped together into a file system. The QFS 2292 may communicate with the database instances 2290, content search servers 2268 and/or indexers 2294 to identify, retrieve, move, and/or update data stored in the network file systems (NFS) 2296 and/or other storage systems.

In some implementations, one or more query servers 2282 may communicate with the NFS 2296 to retrieve and/or update information stored outside of the pod 2244. The NFS 2296 may allow servers located in the pod 2244 to access information over a network in a manner similar to how local storage is accessed. Queries from the query servers 2222 may be transmitted to the NFS 2296 via the load balancer 2228, which may distribute resource requests over various resources available in the on-demand database service environment 2200. The NFS 2296 may also communicate with the QFS 2292 to update the information stored on the NFS 2296 and/or to provide information to the QFS 2292 for use by servers located within the pod 2244.

In some implementations, the content batch servers 2264 may handle requests internal to the pod 2244. These requests may be long-running and/or not tied to a particular customer, such as requests related to log mining, cleanup work, and maintenance tasks. The content search servers 2268 may provide query and indexer functions such as functions allowing users to search through content stored in the on-demand database service environment 2200. The file servers 2286 may manage requests for information stored in the file storage 2298, which may store information such as documents, images, basic large objects (BLOBs), etc. The query servers 2282 may be used to retrieve information from one or more file systems. For example, the query system 2282 may receive requests for information from the app servers 2288 and then transmit information queries to the NFS 2296 located outside the pod 2244. The ACS servers 2280 may control access to data, hardware resources, or software resources called upon to render services provided by the pod 2244. The batch servers 2284 may process batch jobs, which are used to run tasks at specified times. Thus, the batch servers 2284 may transmit instructions to other servers, such as the app servers 2288, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2© by IBM and the like without departing from the scope of present disclosure.

FIG. 23 illustrates one example of a computing device. According to various embodiments, a system 2300 suitable for implementing embodiments described herein includes a processor 2301, a memory module 2303, a storage device 2305, an interface 2311, and a bus 2315 (e.g., a PCI bus or other interconnection fabric.) System 2300 may operate as variety of devices such as an application server, a database server, or any other device or service described herein. Although a particular configuration is described, a variety of alternative configurations are possible. The processor 2301 may perform operations such as those described herein. Instructions for performing such operations may be embodied in the memory 2303, on one or more non-transitory computer readable media, or on some other storage device. Various specially configured devices can also be used in place of or in addition to the processor 2301. The interface 2311 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of application-level distributed denial of service attacks. However, the techniques disclosed herein apply to a wide variety of malicious network activity. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A system comprising:
a plurality of application servers providing computing services to a plurality of entities;
a network ingress receiving a plurality of application-level request messages via a network interface and forwarding some or all of the plurality of application-level request messages to one or more of the application servers;
a data aggregator that determines a plurality of data buckets based on the plurality of application-level request messages, a data bucket of the plurality of data buckets corresponding with a respective period of time, the data bucket including information characterizing one or more of a plurality of features, the information being determined based on a subset of the plurality of application-level request messages received during the respective period of time;
a request analyzer configured to determine one or more of the data buckets and one or more of the plurality of features for analyzing an application-level request message and to determine a synthetic indicator for the application-level request message based on the one or more data buckets and the one or more features; and
a web application firewall configured to block the application-level request message upon determining that the synthetic indicator indicates that the application-level request message is illegitimate.

2. The system recited in claim 1, wherein the one or more data buckets includes a plurality of data buckets that each correspond to a respective period of time and a respective feature of the plurality of features.

3. The system recited in claim 2, wherein the system is configured to select the one or more data buckets by applying a machine learning model to input data that includes request information characterizing the application-level request message.

4. The system recited in claim 3, wherein selecting the one or more data buckets comprises selecting the respective features from the plurality of features.

5. The system recited in claim 3, wherein selecting the one or more data buckets comprises selecting the respective time periods.

6. The system recited in claim 1, wherein determining the synthetic indicator comprises determining a conditional probability for one or more characteristics of the application-level request message based on the one or more of the data buckets.

7. The system recited in claim 6, wherein the conditional probability is determined based on a plurality of weights associated with different features reflected in the conditional probability.

8. The system recited in claim 6, wherein the conditional probability is determined based on a plurality of weights associated with different time periods reflected in the conditional probability.

9. The system recited in claim 6, wherein the conditional probability is determined based on a plurality of weights, a weight of the plurality of weights being specific to a feature and a time period of different features and different time periods reflected in the conditional probability.

10. The system recited in claim 1, the system further comprising:
an orchestration engine configured to determine a plurality of mitigation policies corresponding with a plurality of network ingress paths based on a classification of a subset of the plurality of application-layer request messages as being sent from sources associated with an application-layer distributed denial of service attack, the plurality of mitigation policies including one or more rules to prevent a subset of subsequent application-layer request messages from the sources from reaching one or more components of the system.

11. The system recited in claim 10, wherein the plurality of mitigation policies includes a network layer rule or a transport layer rule to throttle a rate of subsequent requests.

12. The system recited in claim 10, wherein the plurality of mitigation policies includes a network layer rule or a transport layer rule preventing a subsequent application-layer request message from reaching the one or more components of the system.

13. The system recited in claim 10, wherein the application-layer distributed denial of service attack is at an application layer, and wherein the orchestration engine is configured to identify a traffic spike corresponding with the application-layer distributed denial of service attack when a traffic level associated with a portion of the system exceeds a designated threshold.

14. The system recited in claim 10, the system further comprising:
a generative language model interface configured to generate a report characterizing the application-layer distributed denial of service attack by generating novel text to complete a prompt, the prompt including one or more natural language instructions to generate the novel text, the prompt further including analysis information characterizing the application-layer distributed denial of service attack, the prompt further including mitigation information characterizing the plurality of mitigation policies.

15. The system recited in claim 14, wherein the orchestration engine is further configured to identify a recipient of a plurality of recipients that is likely affected by the application-layer distributed denial of service attack and to transmit the report to the identified recipient.

16. The system recited in claim 10, wherein the application-layer distributed denial of service attack is limited to a subset of a plurality of domains and a subset of the plurality of network ingress paths.

17. A method comprising:
providing computing services to a plurality of entities via a plurality of application servers;
receiving a plurality of application-level request messages at a network ingress via a network interface and forwarding some or all of the plurality of application-level request messages to one or more of the application servers;
determining via a processor a plurality of data buckets based on the plurality of application-level request messages, a data bucket of the plurality of data buckets corresponding with a respective period of time, the data bucket including information characterizing one or more of a plurality of features, the information being determined based on a subset of the plurality of application-level request messages received during the respective period of time;
determining via a processor one or more of the data buckets and one or more of the plurality of features for analyzing an application-level request message;
determining a synthetic indicator for the application-level request message via a processor based on the one or more data buckets and the one or more features; and
blocking the application-level request message via a web application firewall upon determining that the synthetic indicator indicates that the application-level request message is illegitimate.

18. The method recited in claim 17, wherein the one or more data buckets includes a plurality of data buckets that each correspond to a respective period of time and a respective feature of the plurality of features, the method further comprising selecting the one or more data buckets by applying a machine learning model to input data that includes request information characterizing the application-level request message.

19. The method recited in claim 17, the method further comprising determining a plurality of mitigation policies corresponding with a plurality of network ingress paths based on a classification of a subset of the plurality of application-layer request messages as being sent from sources associated with a distributed denial of service attack, the plurality of mitigation policies including one or more rules to prevent a subset of subsequent application-layer request messages from the sources from reaching one or more system components.

20. One or more non-transitory computer readable media having instructions stored thereon for performing a method, the method comprising:
providing computing services to a plurality of entities via a plurality of application servers;
receiving a plurality of application-level request messages at a network ingress via a network interface and forwarding some or all of the plurality of application-level request messages to one or more of the application servers;
determining via a processor a plurality of data buckets based on the plurality of application-level request messages, a data bucket of the plurality of data buckets corresponding with a respective period of time, the data bucket including information characterizing one or more of a plurality of features, the information being determined based on a subset of the plurality of application-level request messages received during the respective period of time;
determining via a processor one or more of the data buckets and one or more of the plurality of features for analyzing an application-level request message;
determining a synthetic indicator for the application-level request message via a processor based on the one or more data buckets and the one or more features; and blocking the application-level request message via a web application firewall upon determining that the synthetic indicator indicates that the application-level request message is illegitimate.
